(19) United States
(12) Patent Application Publication
(10) Pub. No.: US 2007/0094281 A1
(43) Pub. Date: Apr. 26, 2007

(54) Application portfolio assessment tool

(76) Inventors: Michael G. Malloy, Novato, CA (US); Michael Paiko, Redwood City, CA (US); Mark J. Addleman, San Francisco, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/259,920

(22) Filed: Oct. 26, 2005

(51) Int. Cl. G06F 7/00

(52) U.S. Cl. 707/100

(57) ABSTRACT

An application portfolio assessment tool and related techniques are provided. The manageability and criticality of a software application implementation are determined to evaluate and compare one or more applications. Sets of application inquiries to assess the manageability and criticality of the application are provided and responses received. Each response is scaled and multiplied by a weighting associated with the corresponding application inquiry. The determined values for each inquiry directed to manageability can be used to calculate a manageability score and the determined values for each inquiry directed to criticality can be used to calculate a criticality score. The results can be graphically depicted to illustrate the relative characteristics of one or more applications. Application risk exposure assessments can also be made using application inquiries. Using the manageability and criticality scores, applications can be selected for performance profiling.

The present application claims the benefit of U.S. Provisional Patent Application No. ______ (Attorney Docket No. WILY-01025US1), entitled “APPLICATION PORTFOLIO ASSESSMENT TOOL,” by Malloy et al., filed Oct. 18, 2005, incorporated by reference herein in its entirety.

### BACKGROUND OF THE INVENTION

1. Field of the Invention

Embodiments are directed to technology for an application portfolio assessment tool and related techniques.

2. Description of the Related Art

Over the past decade or more, many businesses as well as governmental, and non-governmental institutions have rapidly moved to develop and deploy software applications based on the latest technology. The rapid expansion of software deployment has been driven by desires and requirements to improve internal processes, reduce costs, and to otherwise enhance services and/or increase revenue. Many institutions have implemented numerous applications across multiple functions and lines of business.

In many instances, it becomes desirable to improve the implementation of these software applications to maximize availability and performance. For example, performance profiling (or analysis) tools are popular tools to debug software and to analyze an application's run time execution. Many performance profiling tools provide timing data on how long each method (or procedure or other process) is being executed, report how many times each method is executed, and/or identify the function call architecture. Other functions can also be performed by various performance profiling tools. Some of the tools provide their results in text files or on a monitor. Other tools graphically display their results.

The application of performance profiling solutions and other analysis to a software application requires resources, including direct capital, human resources, and time, etc. In many cases, these required resources can present an obstacle to application of performance profiling tools within an institution. Many institutions (which may individually include thousands of applications) simply cannot afford, from a cost, personnel, or time perspective, to apply such solutions to each and every application used. Accordingly, when institutions grow to include numerous applications, the identification of the most important or crucial applications to the institution's function becomes increasingly important so that the solutions are applied to the most appropriate applications.

In many institutions, however, there is no central knowledge of how critical each application is to the success of the organization and the cost of not being able to manage applications more effectively. As application deployment permeates multiple and often numerous business processes, the costs, resources, and business impact of the applications often pass out of the realm of management by a single individual person, department, or process. With a lack of centralized knowledge pertaining to the various applications, the identification of those to which performance analysis should be applied becomes increasingly difficult.

### SUMMARY OF THE INVENTION

An application portfolio assessment tool and related techniques are provided. The manageability and criticality of a software application implementation are determined to evaluate and compare one or more applications. Sets of application inquiries to assess the manageability and criticality of the application are provided and responses received. Each response is scaled and multiplied by a weighting associated with the corresponding application inquiry. The determined values for each inquiry directed to manageability can be used to calculate a manageability score and the determined values for each inquiry directed to criticality can be used to calculate a criticality score. The results can be graphically depicted to illustrate the relative characteristics of one or more applications. Application risk exposure assessments can also be made using application inquiries.

In one embodiment, a method of ranking applications is provided that comprises providing a first set of application inquiries to assess the manageability of a first application, receiving a response to at least one application inquiry in the first set, determining a manageability score for the first application based on the response to the at least one application inquiry in the first set, providing a second set of application inquiries to assess the criticality of the first application, receiving a response to at least one application inquiry in the second set, determining a criticality score for the first application based on the response to the at least one application inquiry in the second set, and creating a ranking for the first application based on the manageability score and the criticality score.

In one embodiment, such a method can further include determining whether the manageability score is above a first threshold value and whether the criticality score is above a second threshold value. The first application can be selected for performance profiling if the manageability score is above the first threshold value and/or the criticality score is above the second threshold value. The performance profiling can be performed for the first application if selected by adding functionality to a set of code for the first application. The set of code can correspond to at least one transaction and adding the functionality can include adding code that activates a tracing mechanism when the at least one transaction starts and terminates the tracing mechanism when the at least one transaction completes. If an execution time of the at least one transaction exceeds a threshold trace period, the first application can be reported. In one embodiment, the functionality can be added directly to object code (e.g., Java byte code) or source code.

### BRIEF DESCRIPTION OF THE DRAWINGS

FIG. 1 is a flowchart in accordance with embodiment for evaluating applications.

FIG. 2 is a block diagram of an application portfolio assessment tool in accordance with one embodiment.

FIGS. 3A-3B depict a data collection component of the application portfolio assessment tool in accordance with one embodiment.

FIGS. 4A-4E depict a client help component of the application portfolio assessment tool in accordance with one embodiment.

FIGS. 5A-5F depict a consultant help component of the application portfolio assessment tool in accordance with one embodiment.

FIG. 6 depicts a manageability score and criticality score calculation component in accordance with one embodiment.

FIG. 7 depicts an application summary component of the application portfolio tool in accordance with one embodiment.

FIG. 8 depicts a quadrant chart of the application portfolio tool in accordance with one embodiment.

FIGS. 9A-9C depict an availability summary component of the application portfolio tool in accordance with one embodiment.

FIGS. 10A-10C depict a performance summary component of the application portfolio tool in accordance with one embodiment.

FIG. 11 depicts an information technology resource summary component of the application portfolio tool in accordance with one embodiment.

FIG. 12 is a block diagram describing how byte code for an application is instrumented in one embodiment.

FIG. 13 is a block diagram of a system for monitoring an application in accordance with one embodiment.

FIG. 14 depicts a graphical user interface in accordance with one embodiment that can be used to report transactions.

FIG. 15 is a block diagram of a computing system that can be used in accordance with one embodiment.

### DETAILED DESCRIPTION

A software application assessment and comparison tool is provided for realizing concrete manageability and criticality assessments of software applications and their various implementations. In accordance with embodiments, the task of analyzing software applications can be codified to realize real results. These results can be implemented as numerical representations in various embodiments to provide values for evaluating and comparing different software applications and their implementations. It is recognized that two features of an application implementation are desirable for evaluation to make meaningful determinations and comparisons. These different areas of assessment allow an institution to analyze which of its software applications require large amounts of resources to manage (i.e., difficult to manage) and to evaluate that manageability in the context of how critical the application is to the organization. The software tool and related techniques further allow the availability, cost of availability, performance, and cost of performance to be evaluated. Taken together, each of these assessments can provide a realizable numerical assessment of the software application that can be used to compare multiple applications and identify those that are deemed most important to an organization and/or most difficult to manage.

A key feature of various embodiments is the centralization of information normally held by multiple disparate groups within an institution. An information technology manager may be responsible for, and have knowledge of the information necessary to determine the manageability of an application. On the other hand, a business executive may be responsible for and have knowledge of the information necessary to determine the criticality of that same application to the institution's revenue attributable to the implementation thereof. The software assessment tool in accordance with embodiments centralizes these distinct types of information into a cohesive representation for properly identifying and ranking an implementation based on both its manageability and criticality. Furthermore, the tool presents cost of availability values, availability percentages, cost of performance values and cost of performance percentages in order to identify the cost associated with maintaining and managing an application as well as the cost attributable to the downtime and lack of performance of the application.

Using the manageability score and criticality score, an application ranking can be created and plotted on a quadrant chart based on those scores. Multiple applications can be plotted in order to view the relative manageability and criticality of various applications. This can help an institution identify which applications are requiring large amounts of resources to manage and which applications are critical.

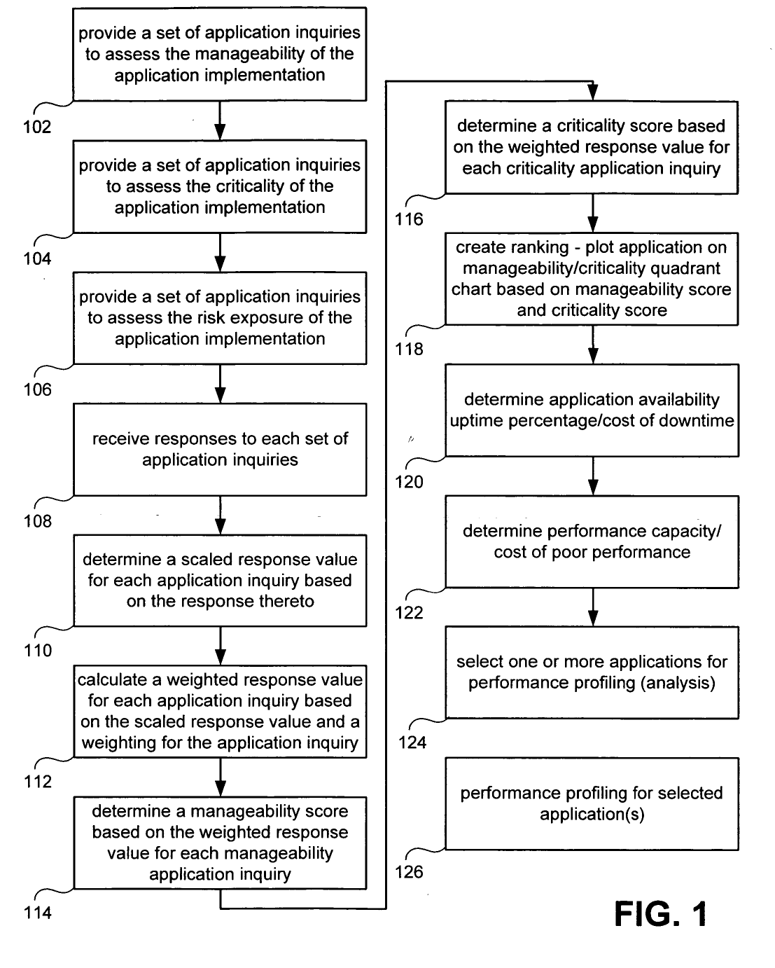

FIG. 1 depicts a process by which a software assessment tool in accordance with one embodiment receives information and provides assessments of applications. The process can create software rankings for multiple applications so that a selection of one or more applications for performance profiling or other analysis can be made. Steps 102-122 can be repeated for each application undergoing assessment. At step 102, a set of application inquiries to assess the manageability of a software application implementation is provided. These inquiries can assess such information as the number of applications that the selected application depends on for data, the number of other applications that depend on the selected application for data, as well as numerous other inquires. Various inquires can be used to assess manageability in accordance with different embodiments and the needs and desires of a particular software application. At step 104, a set of application inquiries to assess the criticality of the software application implementation is provided. For example, these inquiries may include such questions as the downtime for an application, the value of transactions, the average number of transactions, etc. As with the manageability application inquiries, the criticality application inquiries can vary by embodiment. At step 106, a set of application inquiries to assess the risk exposure of an application software implementation is provided. For example, these inquiries can include such things as the average planned downtime, the average number of transactions, the average value of transactions, the average value of customers, etc. As with the other inquiries, the types and number of inquiries to assess application risk exposure can vary by embodiment.

At step 108, responses are received to each of the application inquires. For example, a user may enter a selection at step 108 which is received by the tool in response to the inquiries. At step 110, a scaled response value for each application inquiry is determined. The scaled response value is determined based on the raw data response received at step 108. A scaled response value can be used for each application inquiry to normalize the responses and provide a meaningful numerical assessment of the application. At step 112, a weighted response value is calculated for each application inquiry. The weighted response value for each application inquiry can be determined by multiplying the scaled response value for the inquiry by a weighting for the application inquiry. The weightings can be assigned to application inquiries to reflect a relative importance or significance thereof. At step 114, a manageability score is determined based on the weighted response value for each manageability application inquiry that was provided in step 102. In one embodiment, the score is determined by adding the weighted response values for each manageability application inquiry. At step 116, a criticality score based on the weighted response value for each criticality application inquiry can be determined. This score can be determined in one embodiment by adding the weighted response value to each application inquiry for determining criticality. At step 118, a ranking is created for the application and the application plotted on a manageability/criticality quadrant chart. The ranking is based on the manageability score and criticality score in one embodiment. The quadrant chart can be a four quadrant chart in one embodiment that reflects the relative manageability and criticality of a software application. The ranking can be the quadrant to which the application is assigned based on these scores. Multiple applications can be plotted on a single chart in order to compare them. Moreover, an application can be plotted on the chart at various times reflecting various responses to the application inquiries as an application matures over time. At step 120, the application availability uptime percentage is determined. This value reflects the percentage of time that an application is available for use. Also at step 120, a cost of the downtime for the application is computed. At step 122, a performance capacity percentage is determined for the application. This percentage can reflect a ratio of the desired capacity of the application to the actual capacity of the application. A cost of poor performance can also be determined at step 122. This cost can be the cost of inadequate capacity or can be the cost associated with the difference between the desired capacity and the actual capacity.

At step 124, one or more applications that were assessed using the steps of 102-122 are selected for application of performance profiling or analysis. Many organizations run tens, hundreds, or thousands of applications. As these applications are implemented over time, their manageability and criticality to the corporation can be unknown. In order to streamline certain applications for efficiency and other purposes, it is beneficial to identify those applications which are the hardest to manage and the most critical. If an application is very hard to manage and at the same time very critical to the company, it may be an application that should be assessed and streamlined in order to reduce the manageability costs. Moreover, an application that is not critical to a corporation but has a high manageability cost, should also be assessed in order to decrease its manageability requirements. On the contrary, an application which is not very critical to a corporation and has low manageability costs, would be low in a priority list for ones to be streamlined.

Various techniques can be employed to select applications at step 124. In one embodiment, threshold values for the criticality and manageability scores can be provided. If the manageability score and criticality are each above the threshold value, the application can be selected for profiling. In other embodiments, the manageability score and criticality score can be compared to a threshold value and the application selected if either score is larger than a threshold value. Other combinations of the manageability score and criticality score can be used as well. In one embodiment, the selection at step 124 is automatic. Assessment tool 200 can automatically select those applications meeting the predetermined criteria. In another embodiment, the selection can be made by a user after reviewing the rankings created by the tool.

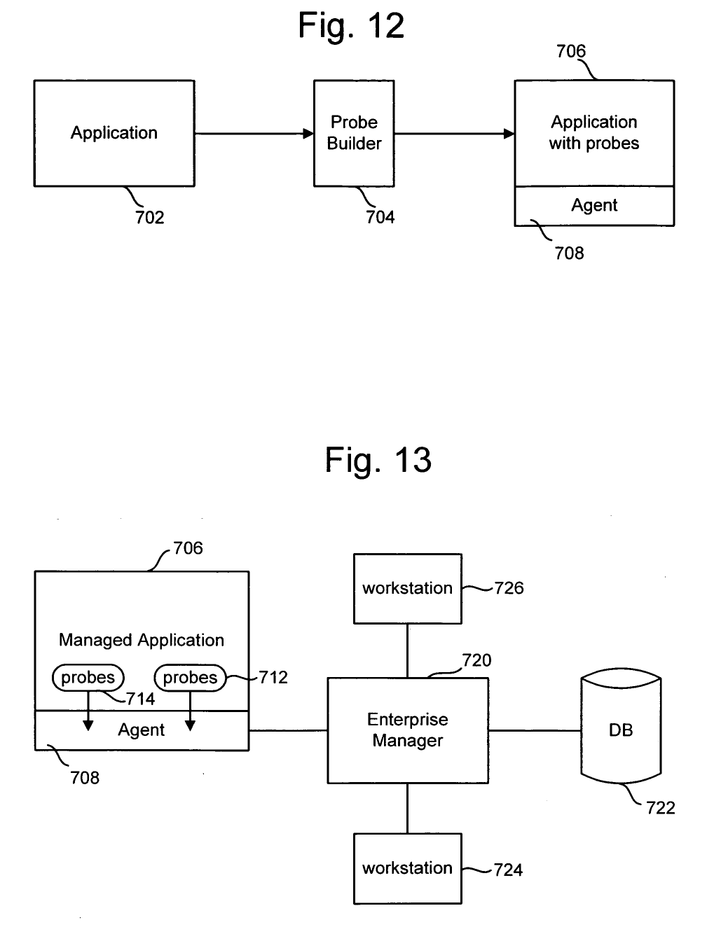

After selecting one or more applications, the performance profiling or analysis is performed at step 126. Many types of analysis and profiling can be performed at step 126. In one embodiment for example, step 126 can include modifying object or source code to add additional functionality. The additional functionality can be used to determine which component of a transaction (method, process, procedure, function, thread, set of instructions, etc.) running in a software application is causing a performance problem. A transaction can have a set of traced component invocations. A transaction tracer (or other data providing mechanism) can allow a user to specify a threshold trace period and initiate transaction tracing on one, some, or all transactions running on a software system. Transactions with an execution time that exceeds the threshold trace period can be reported. Further details and examples regarding performance profiling or analysis are provided below with respect to FIGS. 12-14.

The results of the process of FIG. 1 can be used in various ways in accordance with embodiments. For example, a word processing document can be created at the conclusion of steps 102-122. In one embodiment, a template document is provided. This document can include standardized information pertaining to the analysis of manageability and criticality as well as the results of the analysis performed. In one embodiment, the document is linked to assessment tool 200 such that the information generated during the process is automatically pulled into the document. For example, the responses to application inquiries, scaled and/or weighted response values, manageability and criticality scores, quadrant chart with plotted applications, availability information, and performance information can be automatically inserted into the document. Additionally, a consultant working with a representative of the organization whose applications are being analyzed can add or modify information.

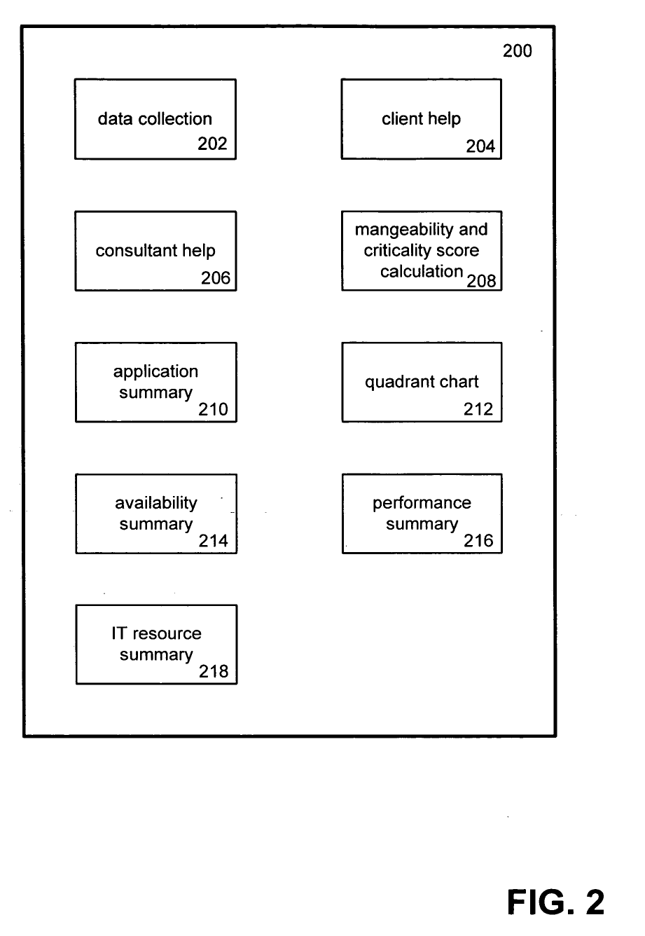

FIG. 2 depicts a software assessment tool 200 in accordance with one embodiment. Tool 200 includes a data collection component 202 that can provide multiple sets of application inquiries and collect raw data from a user, database, network, etc. in response to the inquiries. The application inquiries can be divided into a set for assessing manageability, a set for assessing criticality, and a set for assessing application risk exposure. In one embodiment, data collection component 202 performs steps 102-108 of FIG. 1. To assist with the data collection component 202, a client help component 204 and a consultant help component 206 are also provided. Client help component 204 can include each of the application inquiries provided by data collection component 202. In addition to the application inquiries, client help component 204 can provide an explanation for how to answer each of the application inquiries. Each of these explanations can be tailored to an end user or client who possesses or manages the application implementation that is being assessed by the application assessment portfolio tool. The client help component 204 can also list the particular individual within an organization who is most likely to possess the information necessary to answer each of the application inquiries. For example, the client help component can specify that an application server administrator is particularly suited to answer certain questions, the application owner suited to answer other questions, and the business owner particularly suited to answer other questions.

Consultant help component 206 can include the same information as client help component 204. It can include explanations on how to answer each of the application inquiries that are tailored to the end user or client having the applications under assessment as well as an identification of the individual or individuals most likely to possess the information necessary to answer an application inquiry. In addition, the consultant help component can also contain explanations to assist a consultant who is working with a client owner of an application in order to help that consultant better ascertain and receive the necessary information from the end user. For instance, a consultant may interview one or more individuals at a corporation or business in order to obtain responses to each of the application inquiries. The additional information provided by consultant help component 206 can assist that consultant in procuring the correct information.

Manageability score and criticality score calculation component 208 can process the raw data received by component 202 to provide manageability and criticality scores based on weighted response values for each inquiry. The raw data for each inquiry can be assigned a scaled value, for example, based on what range of predetermined response values the raw data value falls within. This scaled value can be multiplied by a weighting assigned to the particular inquiry to develop a weighted response value. The manageability score can be calculated by adding the individual weighted response values for each inquiry within the set of manageability application inquiries. The criticality score can be calculated in the same way using the responses to the application inquiries for assessing criticality. In one embodiment, calculation component 208 performs steps 110-116 of FIG. 1.

Software assessment tool 200 further includes an application summary component 210. The application summary component lists each application for the client that has undergone analysis, such as by receiving responses to the application inquiries provided by data collection component 202 and the values calculated therefore by calculation component 204. In the application summary component, a graphical depiction is provided that lists the manageability score and criticality score calculated by calculation component 208. The summary component also lists the quadrant (discussed in detail hereinafter) to which the application has been assigned based on its manageability and criticality scores. Moreover, the summary component also provides data relating to the application risk exposure which can be determined from the application inquiry responses. This information can include the uptime availability percentage of the application and the corresponding annual cost associated with the downtime thereof. The summary component can further detail a performance capacity percentage for each application which is a value indicative of the ratio between the desired capacity for the application and the actual capacity which has been achieved. Corresponding thereto, the annual cost of poor performance attributable to a lack of capacity is provided for each application.

A quadrant chart component 212 is provided to graphically depict the relative manageability and criticality of each application. In one embodiment, the quadrant chart can include four quadrants. An application is assigned to one of the four quadrants based on whether its manageability score is above or below a threshold value and whether its criticality score is above or below a threshold value. The quadrant chart can provide an easily interpretable graphical depiction for an end user to view the relative importance based on manageability and criticality for one or more applications.

A cost of availability summary component 214 is provided to calculate and graphically depict various values relating to the availability of an application. The summary component can include such information as the planned downtime for an application, the unplanned downtime, the volume of customers or transactions serviced per day, the average value of a customer or transaction, the application availability percent, the total number of transactions impacted by a lack of availability, the total value of all transactions, a potential percentage of impacted customers or transactions that are lost due to poor availability, and the number of transactions or customers that are lost due to poor availability. The summary component can provide a final figure to show the potential lost customer value or the potential lost transaction value associated with poor availability. Cost of performance summary component 216 can provide information similar to that of the cost of availability summary component, however, this data will relate to the cost of performance. Information that can be included in the performance summary component can include the desired transaction capacity, actual transaction capacity, the average customer value or transaction value, the application performance percentage, the total number of impacted transactions, the value of impacted transactions, the percentage of impacted transactions that are lost, and the potential percentage of lost transactions or customers due to poor performance. The summary component can include a final value illustrating the potential lost transaction or customer value revenue associated with poor performance (lack of capacity).

IT resource summary component 218 can depict the human resource cost associated with an application based on the percentage of time spent by various types of individuals on application performance and availability. This summary component can detail such positions as architect developers, server administrators, etc., their annual costs, hourly costs, percentage of time spent, and the average annual cost for each of these people to maintain availability and performance. The IT resource summary component can provide a total annual human resource cost associated with an application based on the amount of time and value associated with each of these types of individuals.

In one embodiment, assessment tool 200 is implemented as an n-tier based design including a relational database, application server, Web server, and a wizard based graphical user interface. The relational database can include information such as inquiry responses (e.g., multiple sets representing different points in time), manageability and criticality scores, availability summary component calculations, performance summary calculations, etc. The application server, Web server, and GUI can interact to provide a user-friendly application that is accessible via simple Web access. In one embodiment, the assessment tool is integrated with an information technology asset management system and customer relationship system that allows the tool access to the most up to date technical and business data. This allows the tool to provide real time criticality and manageability rankings for each of the organization's applications using dynamically updated data. For example, inquiry responses can be dynamically determined from these systems. In one embodiment, the tool aggregates the results from multiple organizations to create industry averages that can be used by an organization to benchmark their applications.

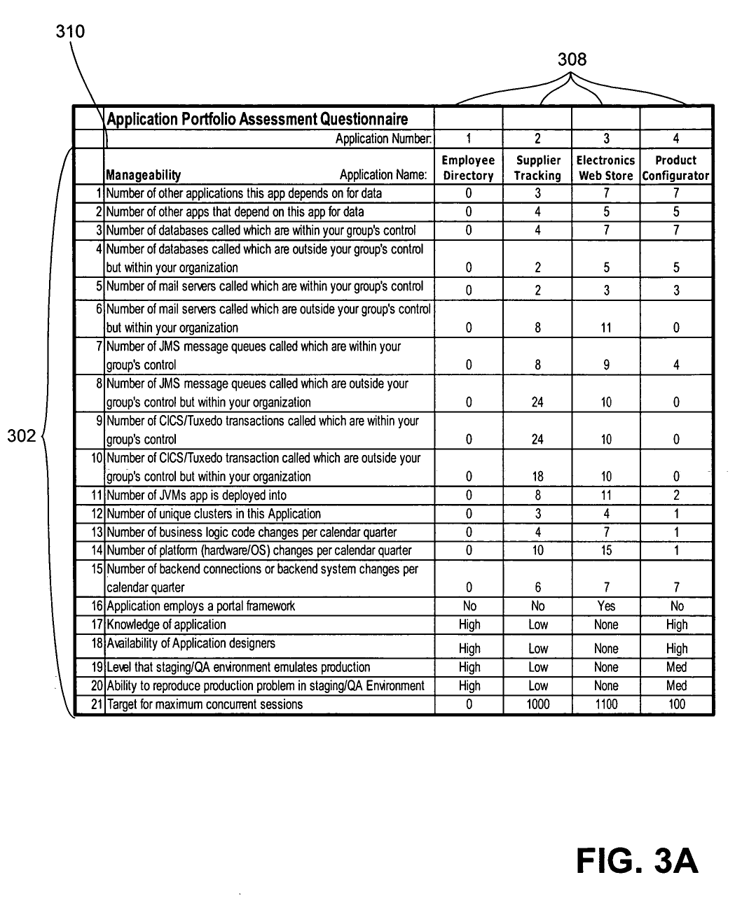

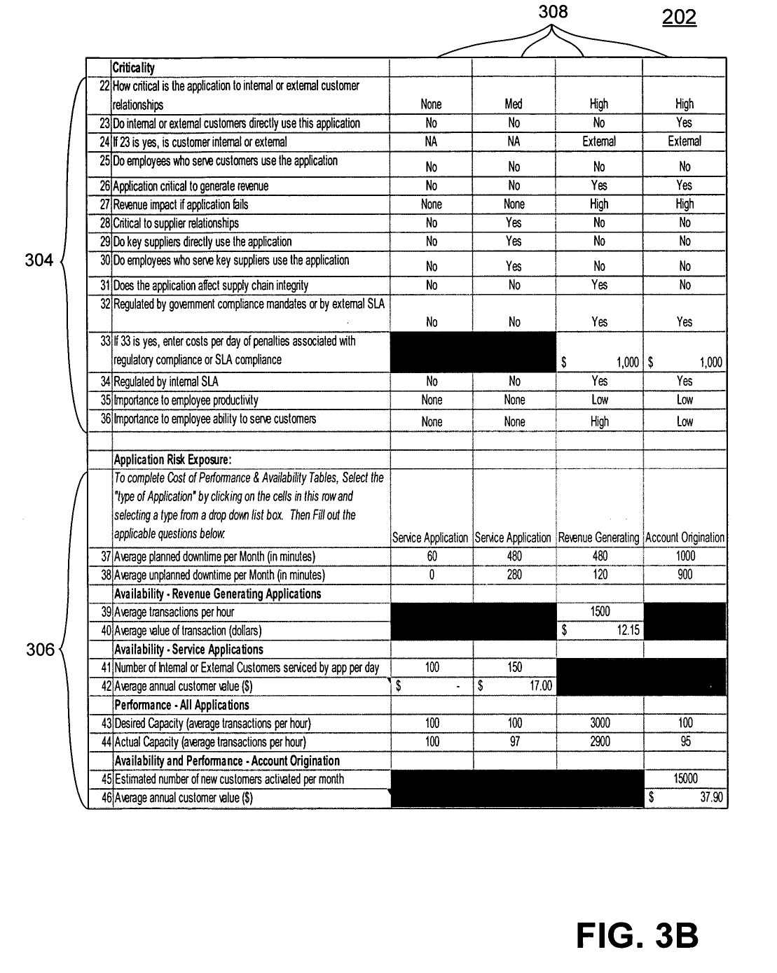

In one embodiment, assessment tool 200 can be implemented as one or more spreadsheets. FIGS. 3A and 3B depict one embodiment of data collection component 202. In this embodiment, data collection component 202 is implemented as one or more spreadsheets. However, other implementations can be made. FIG. 3A depicts a set of application inquiries 302 (numbered 1-21) for receiving information regarding the manageability of the application implementation. A specific set of inquiries 302 is provided in this example, but other implementations can include other inquiries in addition to or in lieu of the specific inquiries provided herein. A number of columns 308 are provided for collecting information for multiple applications. Four applications (numbered 1-4) are represented in this exemplary embodiment. Any number of columns can be provided to collect data for any number of applications. In FIGS. 3A and 3B, application #1 is an employee directory, application #2 is a supplier tracking application, application #3 is an electronics web store application, and application #4 is a product configurator application.

In FIG. 3B a set of application inquiries 304 for receiving information regarding the criticality of the application implementation is provided. A specific set of inquiries 304 is provided in this example, but other implementations can include other inquiries in addition to, or in lieu of, the specific inquiries provided herein. Another set of application inquiries 306 is provided for receiving information regarding the application risk exposure of the application implementation. Again, although a specific set of inquiries 306 is provided, other implementations can include additional inquiries or other inquiries in lieu of those provided in the exemplary embodiment.

The responses to the various application inquiries can take various forms. Looking at inquiries 1-15 for example, it is seen that each of the received response values are numerical values, while other types of response values have been received for inquiries 16-20. In question 16, the answer is a simple yes or no response, while in inquiries 17-20, the response can be one of “none,” “low,” “high,” or “medium.” As will be discussed hereinafter, the various types of responses are used to determine a scaled response value when using calculation component 208.

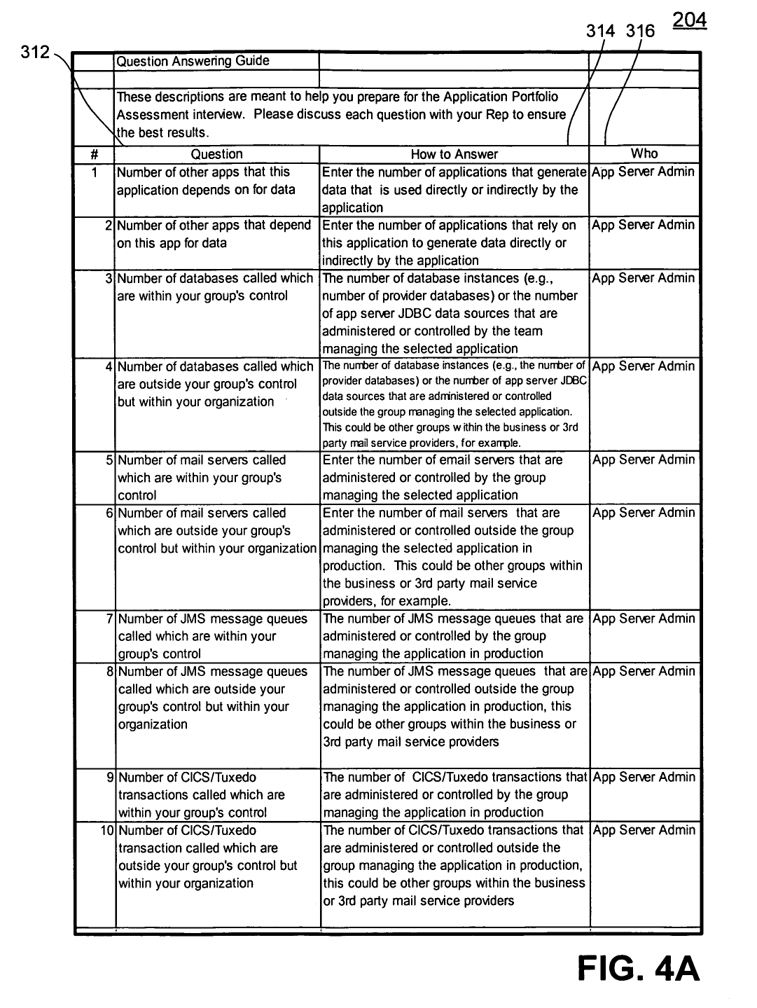

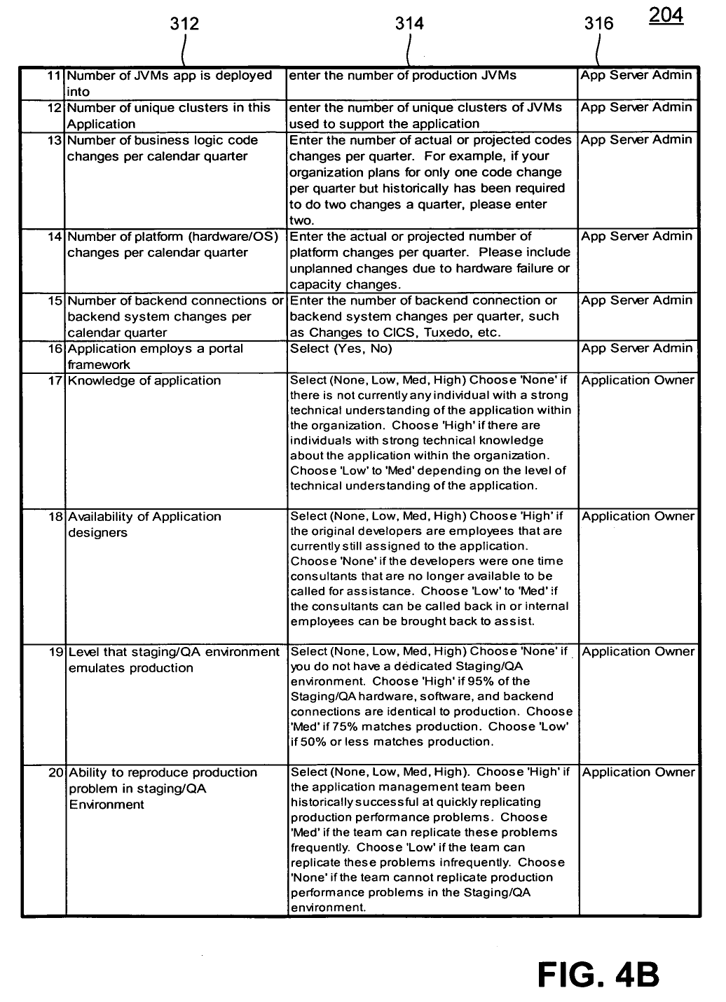

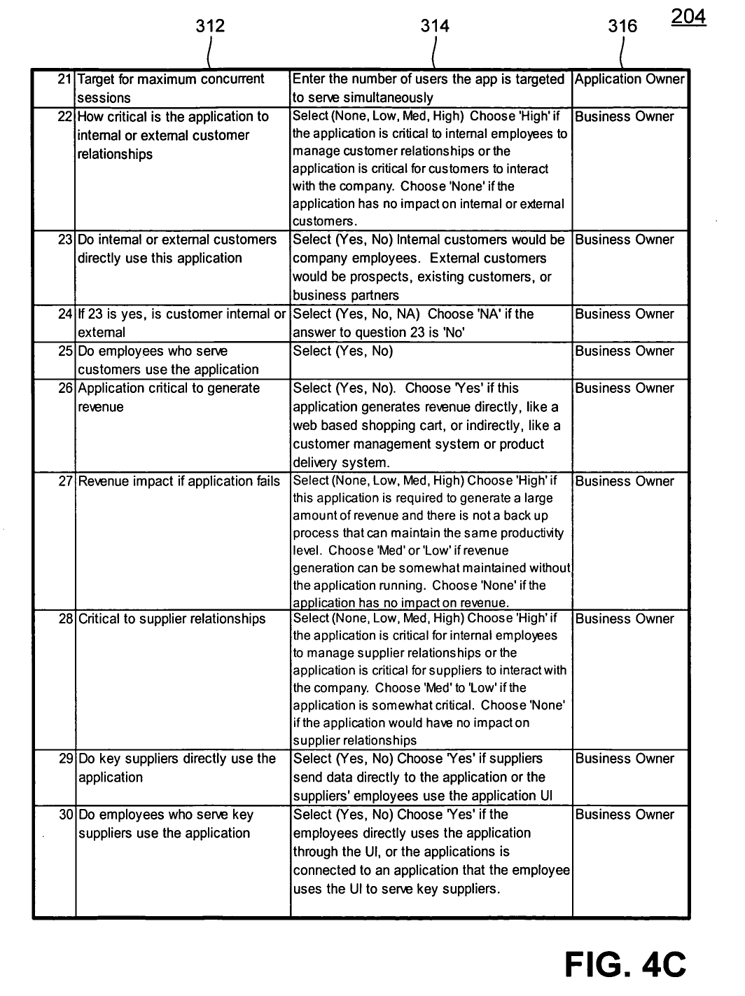

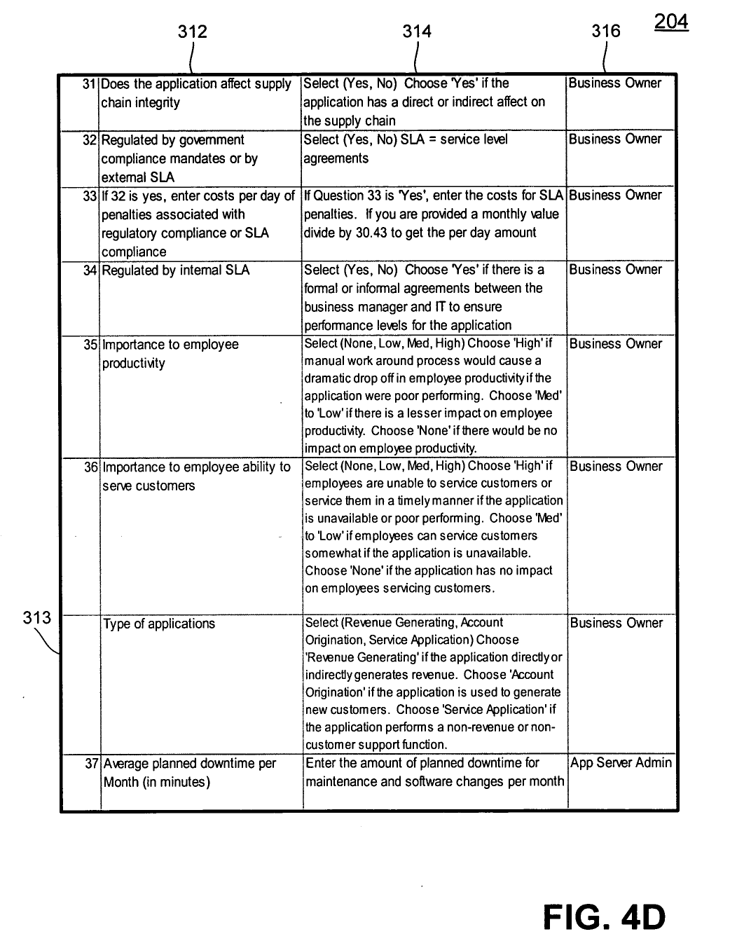

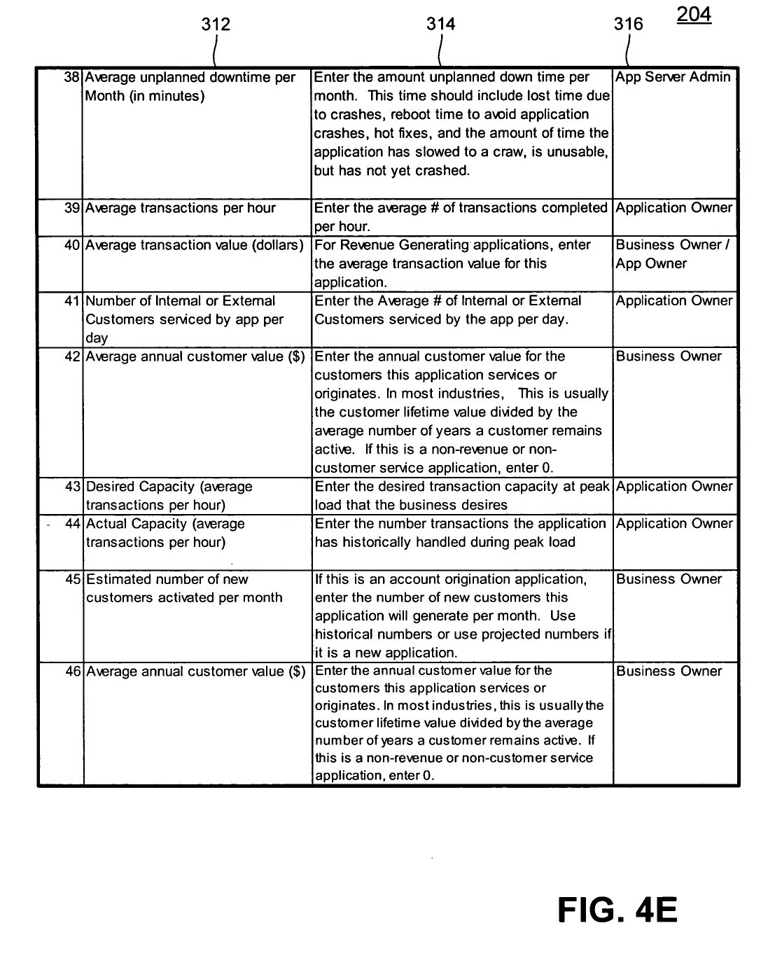

FIGS. 4A through 4E depict one embodiment of client help component 204. The various application inquiries 302, 304, 306 are listed in column 312. Explanations for how to respond to each inquiry are provided in column 314. The relevant individual or individuals that have or are most likely to have knowledge of and can respond to each inquiry are provided in column 316. Various embodiments can include various application inquiries. Accordingly, the explanations provided in column 314 and individuals listed in column 316 can vary by embodiment.

By way of non-limiting example, the exemplary inquiries and other information provided in the example are described. Inquiry 1 determines the number of applications that the selected application depends on for data. In one embodiment as detailed in help component 204, this is the number of applications that generate data that is used directly or indirectly by the application. Help component 204 explains that an application server administrator is most likely to have this information. Inquiry 2 determines the number of applications that depend on the selected application for data. This could be the number of applications that rely on the selected application to generate data directly or indirectly. Inquiry 3 determines the number of databases the selected application calls and that are within the control of the group, business, or institution that controls the selected application. This could be the number of database instances (e.g., the number of Oracle™ databases) or the number of application server Java™ Database Connectivity (JDBC) data sources that are administered or controlled by the team managing the selected application. Inquiry 4 determines the number of databases which the selected application calls and that are not within the control of the group that controls the selected application. This can be the number of database instances (e.g., the number of Oracle™ databases) or the number of application server JDBC data sources that are administered or controlled outside the group managing the selected application. The outside groups could be other groups within the business or 3rd party data service providers, etc. Inquiry 5 determines the number of mail servers that are called by the selected application and that are within the control of the group that controls the selected application. This can be the number of email servers that are administered or controlled by the group managing the selected application. Inquiry 6 determines the number of mail servers that the selected application calls and that are not within the control of the group that controls the selected application. This may be the number of mail servers that are administered or controlled outside the group managing the application in production. The groups may be other groups within the business or outside the business such as third party mail service providers, etc. Inquiry 7 determines the number of Java™ Messaging Service (JMS) message queues that are called and within the group's control. The number may be the number of JMS message queues that are administered or controlled by the group managing the selected application.

Inquiry 8 determines that number of JMS message queues that are called and not within the group's control but are within the organization associated with the selected application. The number can be the number of JMS message queues that are administered or controlled outside the group managing the selected application, which could include other groups within the business or outside of the business such as 3 rd party mail service providers, etc. Inquiry 9 determines the number of Customer Information Control System (CICS) or Tuxedo transactions that are called and within the group's control. Inquiry 10 determines the number of CICS or Tuxedo transactions that are called and not within the group's control but within the organization's control. This may be the number of CICS/Tuxedo transactions that are administered or controlled outside the group managing the selected application and could include other groups within the business or 3rd party mail service providers, for example. Inquiry number 11 determines the number of Java™ Virtual Machines (JVMs) the selected application is deployed into. This can be the number of production JVMs.

Inquiry 12 determines the number of clusters in the selected application which can be the number of unique clusters of JVMs used to support the selected application. Inquiry 13 determines the number of business logic code changes the selected application undergoes per calendar quarter. This can be the number of actual or projected codes changes per quarter. For example, if the organization plans for only one code change per quarter but historically has been required to do two changes a quarter, two could be entered as column 314 specifies. Inquiry 14 determines the number of platform (hardware/operating system) changes the selected application undergoes per calendar quarter. This may be the actual or projected number of platform changes per quarter. Unplanned changes due to hardware failure or capacity changes can be included. Inquiry 15 determines the number of backend connections of backend system changes the selected application undergoes each calendar quarter. The number of backend connection or backend system changes per quarter, such as Changes to CICS, Tuxedo, etc. can be entered. Inquiry 16 determines (YES/NO) whether the selected application employs a portal framework. Inquiry 17 determines the level of knowledge (HIGH/MED/LOW/NONE) of those managing the application. Column 316 explains that ‘None’ can be selected if there is not currently any individual with a strong technical understanding if the application within the organization, ‘High’ can be selected if there are individuals with strong technical knowledge about the application within the organization, and ‘Low’ to ‘Med’ selected depending on the level of technical understanding of the application.

Inquiry 18 determines the level of availability (HIGH/MED/LOW/NONE) of the designers of the application. ‘High’ can be selected if the original developers are employees that are currently still assigned to the application, ‘None’ selected if the developers were one time consultants that are no longer available to be called for assistance, and ‘Low’ to ‘Med’ selected if the consultants can be called back in or internal employees can be brought back to assist. Inquiry 19 determines the level (HIGH/LOW/MED/NONE) that staging/QA environment emulates production. Column 316 provides that ‘None’ can be selected if the organization does not have a dedicated staging/QA environment, ‘High’ selected if 95% of the staging/QA hardware, software, and backend connections are identical to production, ‘Med’ selected if 75% matches production, and ‘Low’ selected if 50% or less matches production. Inquiry 20 determines the ability (HIGH/LOW/MED/NONE) to reproduce production problems in the staging/QA environment. ‘High’ can be selected if the application management team has been historically successful at quickly replicating production performance problems, ‘Med’ selected if the team can replicate these problems frequently, ‘Low’ selected if the team can replicate these problems infrequently, and ‘None’ selected if the team cannot replicate production performance problems in the staging/QA environment. Inquiry 21 determines the target for maximum concurrent sessions of the application, which is the number of users the app is targeted to serve simultaneously

Inquiry 22 determines how critical the application is to internal or external customer relationships. Column 314 explains that ‘High’ should be chosen if the application is critical for internal employees to manage customer relationships or if the application is critical for customers to interact with the company and that ‘None’ should be selected if the application has no impact on internal or external customers. Inquiry 13 determines if internal or external customers directly use this application. Column 314 explains that internal customers are company employees, and external customers are prospects, existing customers, or business partners. If 23 is yes, inquiry 24 determines if the customer is internal or external Inquiry 25 determines if employees who serve customers use the application.

Inquiry 26 determines whether the application is critical to generate revenue. ‘Yes’ is to be selected if this application generates revenue directly (e.g., a web-based shopping cart) or indirectly (e.g., a customer management system or product delivery system). Inquiry 27 determines the revenue impact if the application fails. ‘High’ is to be selected if the application is required to generate a large amount of revenue and there is not a back up process that can maintain the same productivity level. ‘Med’ or ‘Low’ are selected if revenue generation can be somewhat maintained without the application running and ‘None’ is selected if the application has no impact on revenue. Inquiry 28 determines how critical the application is to supplier relationships. ‘High’ is selected if the application is critical for internal employees to manage supplier relationships or if the application is critical for suppliers to interact with the company. ‘Med’ to ‘Low’ is selected if the application is somewhat critical and ‘None’ is selected if the application would have no impact on supplier relationships

Inquiry 29 determines if key suppliers directly use the application. ‘Yes’ is selected if suppliers send data directly to the application or if the suppliers' employees use the application user interface (UI). Inquiry 30 determines if employees who serve key suppliers use the application. ‘Yes’ is selected if the employees directly uses the application through the UI, or if the application is connected to an application that the employees use to serve key suppliers. Inquiry 31 determines if the application affects supply chain integrity.‘Yes’ is to be selected if the application has a direct or indirect affect on the supply chain. Inquiry 32 determines whether the application is regulated by government compliance mandates or by external service level agreements (SLA). If inquiry 32 is yes, inquiry 33 determines the costs per day of penalties associated with regulatory compliance or SLA compliance. The costs for SLA penalties are to be entered and divided by 30.43 to get the per day amount if a monthly value is provided.

Inquiry 34 determines whether the application is regulated by internal SLAs. ‘Yes’ is selected if there are formal or informal agreements between a business manager and IT personnel to ensure performance levels for the application. Inquiry 35 determines the application's importance to employee productivity. ‘High’ is selected if a manual work around process would cause a dramatic drop off in employee productivity if the application were poor performing. ‘Med’ to ‘Low’ are selected if there is a lesser impact on employee productivity. ‘None’ is selected if there would be no impact on employee productivity. Inquiry 36 determines the importance to employee ability to serve customers. ‘High’ is selected if employees are unable to service customers or service them in a timely manner if the application is unavailable or poor performing. ‘Med’ to ‘Low’ are selected if employees can service customers somewhat if the application is unavailable and ‘None’ is selected if the application has no impact on employees servicing customers.

In row 313, the type of application is selected. ‘Revenue Generating’ is selected if the application directly or indirectly generates revenue. ‘Account Origination’ is selected if the application is used to generate new customers. ‘Service Application’ is selected if the application performs a non-revenue or non-customer support function. The average planned downtime per month is determined by inquiry 37. The amount of planned downtime for maintenance and software changes per month can be entered. The average unplanned downtime per month is determined by inquiry 38. The amount of unplanned down time per month is entered. Column 314 specifies that this time should include lost time due to crashes, reboot time to avoid application crashes, hot fixes, and the amount of time the application has slowed to a crawl (unusable, but has not yet crashed). The average number of transactions per hour is determined by inquiry 39. The average # of transactions completed per hour is to be entered.

The average transaction value (dollars) is determined by inquiry 40. For revenue generating applications, the average transaction value for the application is entered. The number of internal or external customers serviced by the application per day is determined by inquiry 41. The average number of internal or external customers serviced by the application per day is entered. The average annual customer value is determined by inquiry 42. The annual customer value for customers that the selected application services or originates is to be entered. In many industries, this is the customer lifetime value divided by the average number of years a customer remains active. For non-revenue or non-customer service application 0 is to be entered. The desired capacity (average transactions per hour, e.g.) is determined by inquiry 43. This can be the desired transaction capacity at peak load that the business desires. The actual capacity is determined by inquiry 44. This can be the number of transactions the application has historically handled during peak load. The estimated number of new customers activated per month is determined by inquiry 45. If the application is an account origination application can be entered. The number of new customers the application will generate per month can be entered. Historical numbers or projected numbers (if it is a new application) can be used. The average annual customer value is determined by inquiry 46. The annual customer value for customers that the application services or originates is to be entered. In many industries, this is the customer lifetime value divided by the average number of years a customer remains active. For non-revenue or non-customer service application, 0 can be entered.

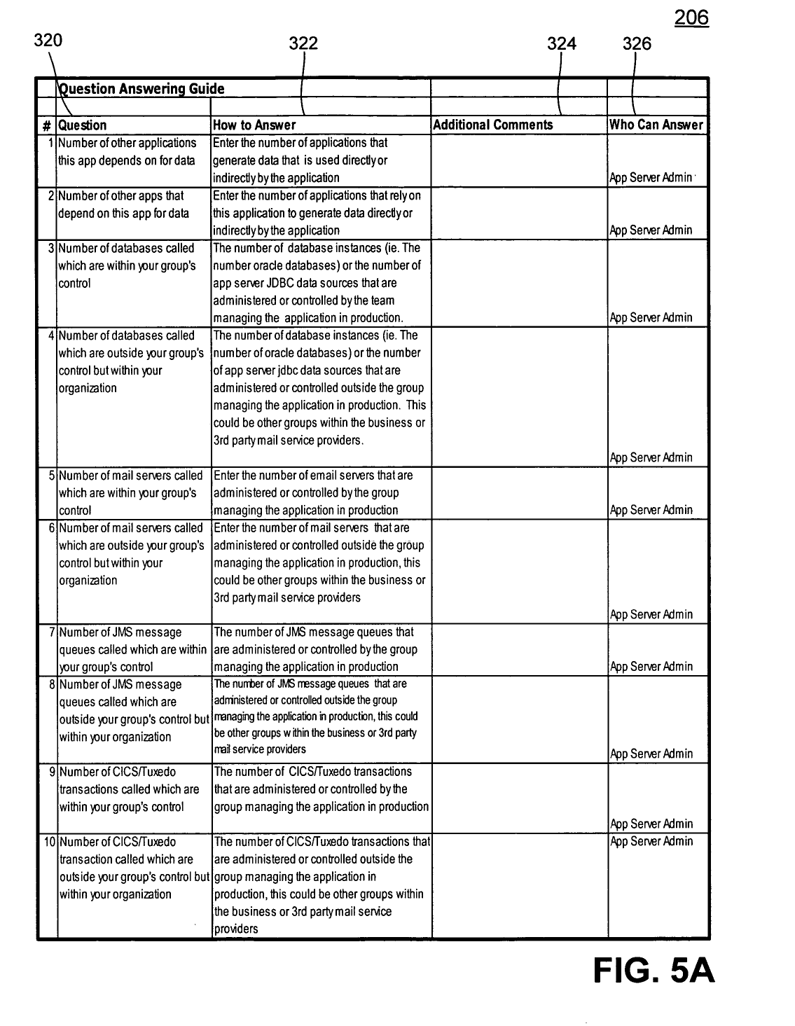

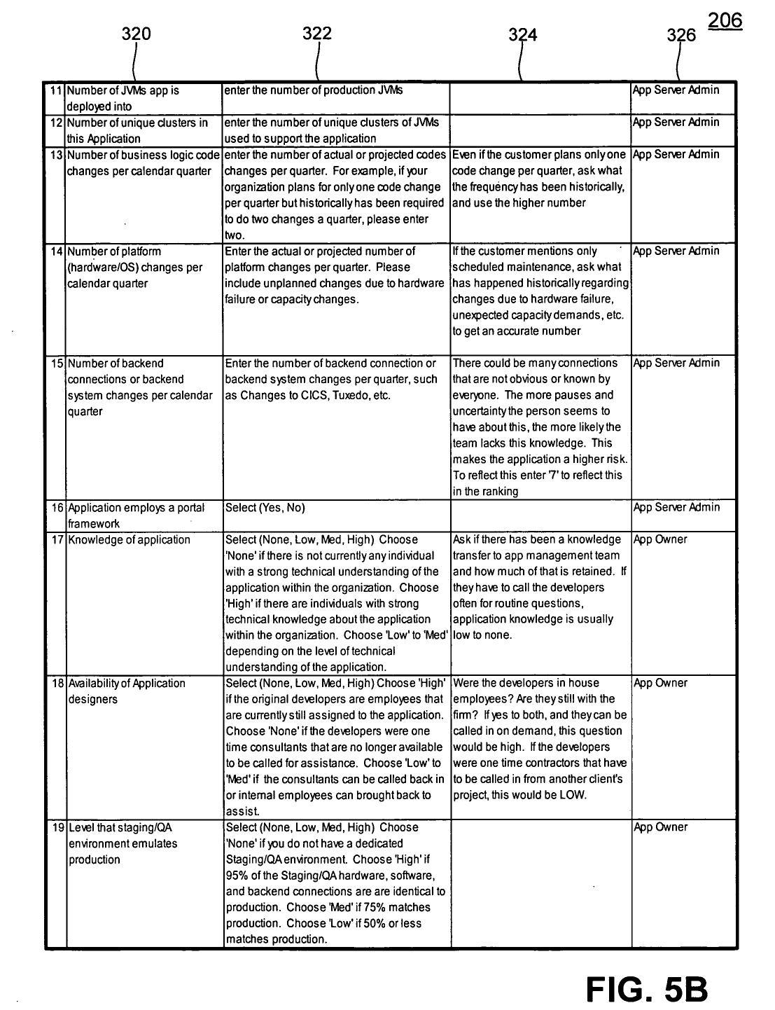

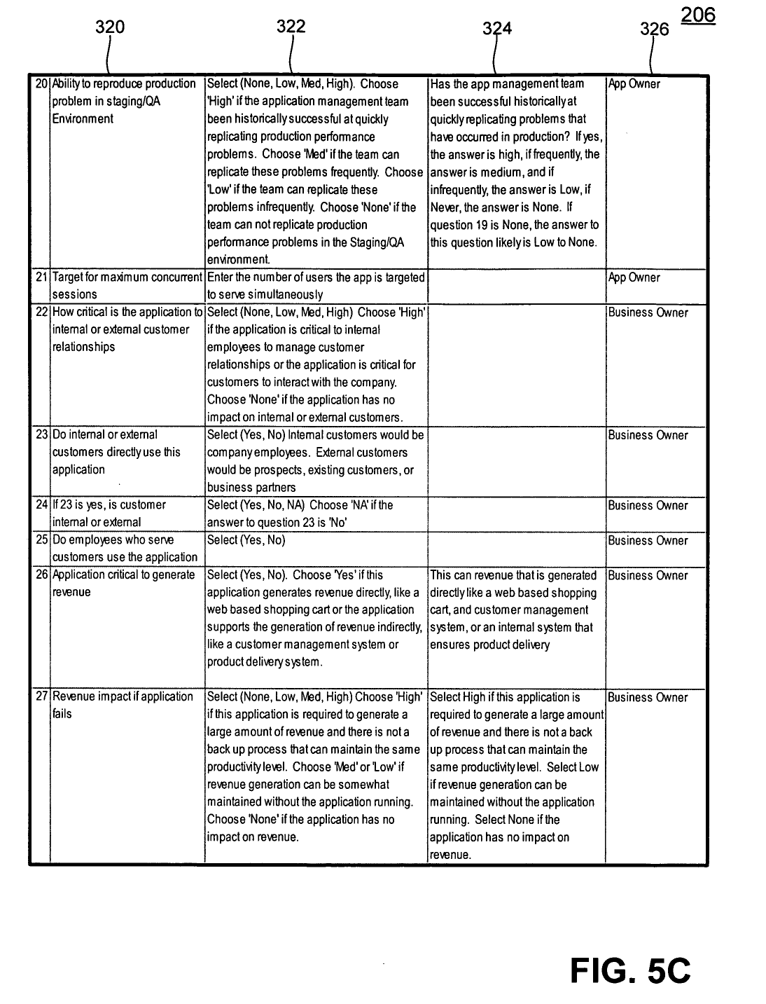

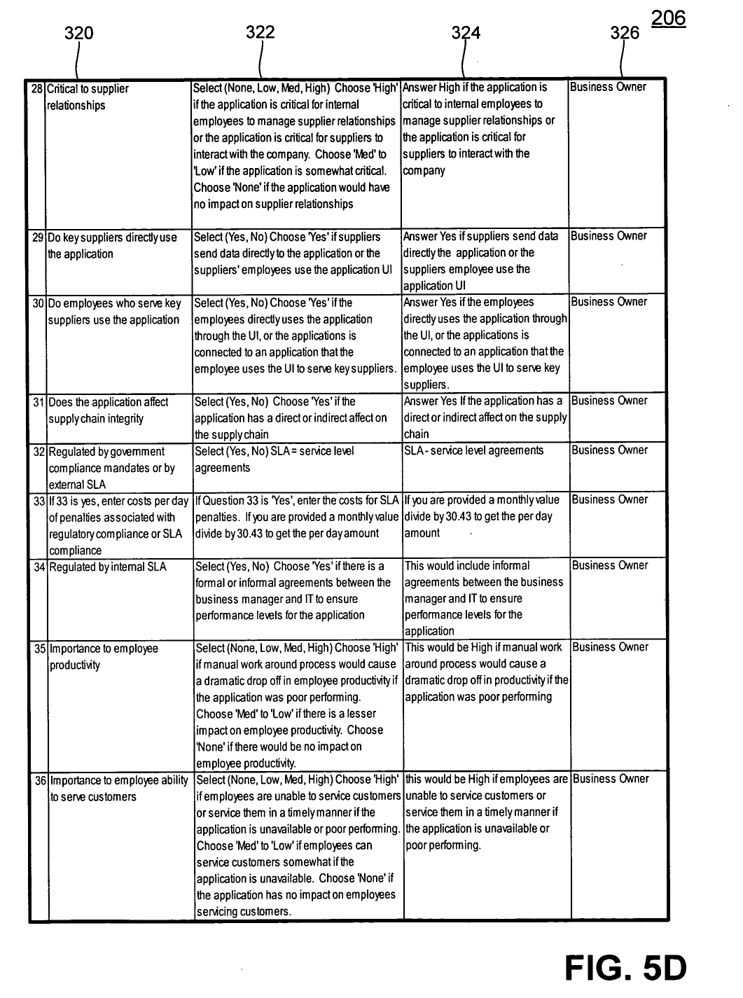

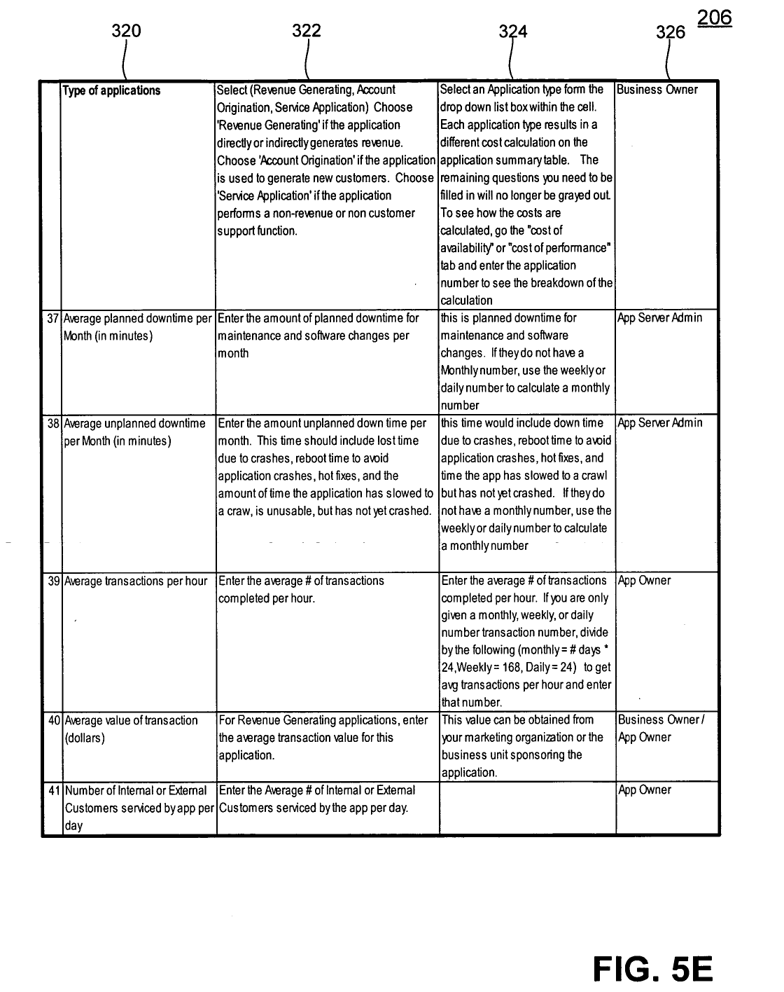

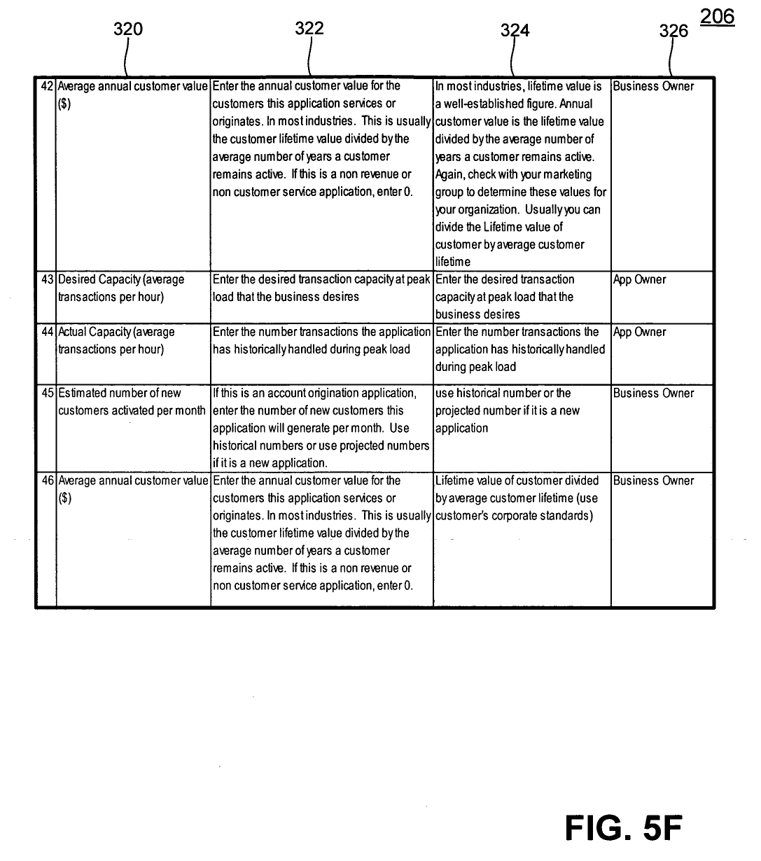

FIG. 5A-5F depict one embodiment of consultant help component 206. Component 206 can be used by one or more individuals consulting with those to whom the questionnaire is directed. For example, a business may provide consulting services in which the application portfolio assessment tool is used. Help component 204 can be provided to those receiving the consulting services while help component 206 can be directly used by those providing the consulting services. In component 206, the application inquiries are again listed in column 320, the explanation of how to respond to each inquiry listed in column 322, and the relevant individual or individuals that may have knowledge and can respond to each inquiry listed in column 326.

In addition, column 324 is provided for the consultant(s) providing services to an end user or client such as the organization utilizing the application(s) being assessed by tool 200. Column 324 provides additional information to that found in column 322. The information can direct a consultant as to how the inquiry should be answered. It can contain further information for locating, deducing, etc. the pertinent information. The particular information provided in the embodiment of FIGS. 5A-5F is presented by way of non-limiting example. Various embodiments may include additional information in lieu or in place of that found in column 324. In embodiments using additional or different application inquiries, other information can be provided.

Exemplary additional information has been provided in column 324 for application inquiry 13. The information advises that even if the customer plans only one code change per quarter, they should be asked for an historical figure so that the higher number can be used. For inquiry 14, column 324 advises that if the customer mentions only scheduled maintenance, they should be asked for historical information regarding changes due to hardware failure, unexpected capacity demands, etc., to get an accurate number. For inquiry 15, column 324 recognizes that there could be many connections that are not obvious or known by everyone and that the more pauses and uncertainty the person seems to have about this, the more likely the team lacks the knowledge. This can make the application a higher risk and to reflect this, the consultant is advised to enter ‘7’ for the ranking. For inquiry 17, column 324 advises to ask if there has been a knowledge transfer to an application management team-and how much of that knowledge has been retained. If the client has to call the developers often for routine questions, application knowledge is usually low to none.

For inquiry 18, column 324 sets forth relevant inquiries to establish designer availability. For example, were the developers in house employees? Are they still with the firm? If yes, and they can be called on demand, this response should be ‘High.’ If the developers were one time contractors that have to be called in from another client's project, the response should be ‘Low.’ For inquiry 20, column 324 advises to ask if the application management team been successful historically at quickly replicating problems that have occurred in production? If yes, the response should be ‘High.’ If frequently, the answer should be ‘Medium.’ If infrequently, the answer should be‘Low.’ If never, the answer should be ‘None.’ If the response to inquiry 19 is ‘None,’ the response to 20 most likely should be ‘Low’ to ‘None.’

For inquiry 26, column 324 states that the revenue can be generated directly (e.g., a web based shopping cart or customer management system), or revenue that is dependent upon an internal system to ensure product delivery. For inquiry 27 ‘High’ should be selected if this application is required to generate a large amount of revenue and there is not a back up process that can maintain the same productivity level, ‘Low’ should be selected if revenue generation can be maintained without the application running, and ‘None’ selected if the application has no impact on revenue. For inquiry 28, ‘High’ is selected if the application is critical for internal employees to manage supplier relationships or if the application is critical for suppliers to interact with the company. For inquiry 30, ‘Yes’ is selected if suppliers send data directly the application or if the suppliers employees use the application UI. For inquiry 31, ‘Yes’ is selected if the employees directly use the application through the UI, or if the application is connected to an application that the employees use the UI to serve key suppliers.

For inquiry 32, ‘Yes’ is selected if the application has a direct or indirect affect on the supply chain. For the type of application, column 324 advises to select an application type form the drop down list box within the cell and that each application type results in a different cost calculation in the application summary component. The remaining questions that need to be filled in will no longer be grayed out and to see how the costs are calculated, go to the “cost of availability” or “cost of performance” tab and enter the application number to see the breakdown of the calculation. For inquiry 40, column 324 advises that the value may be obtained from the marketing organization or the business unit sponsoring the application.

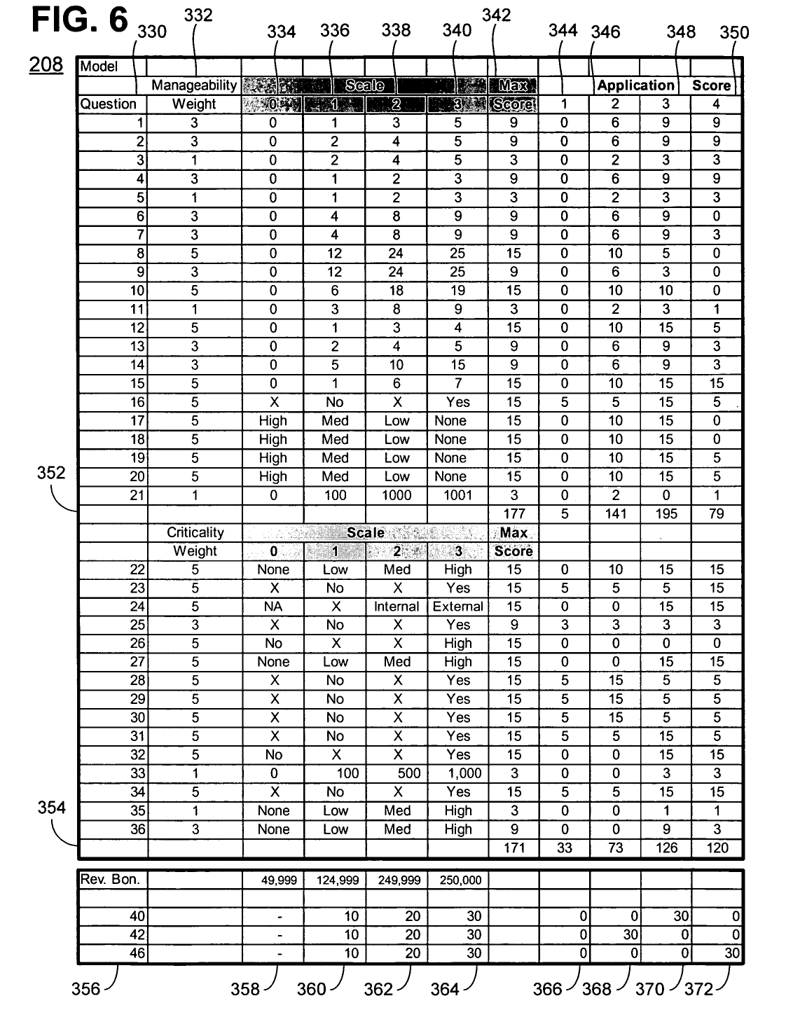

FIG. 6 depicts one embodiment of manageability score and criticality score calculation component 208. In one embodiment, calculation component 208 is implemented as one or more spreadsheets or worksheets. Column 330 of component 208 denotes and corresponds directly to the inquires of data collection component 202. Column 332 sets forth the weighting assigned to each application inquiry. The weighting signifies the weight or importance assigned to each application inquiry. The weighting is used to reflect that some factors represented by an application inquiry will have a larger effect on manageability or criticality than other factors represented by other application inquiries. In the embodiment of FIG. 6, the weightings assigned to each inquiry range from 1 (least significant) to 5 (most significant). In other embodiments, a different range of values can be used. Moreover, different weightings can be assigned to the inquiries than those depicted in FIG. 6. For example, one may decide that the number of databases called which are within the control of the group in charge of the selected application (inquiry 3 ) should be weighted as a more significant contributor to manageability. To reflect this, the weighting can be adjusted from a 1 to a 3 or other value.

Columns 334-340 include predetermined response value ranges for each application inquiry. Depending on the range or other criteria that the raw data value received from a user (through data collection component 202 ) falls within, a scaled value of 0, 1, 2, or 3 (top of each column), is assigned to the application inquiry. The scaled response values are used to normalize the various response values that can be received for each application inquiry so that a meaningful score can be calculated. Various options for setting up the scaled response calculations can be established. In this example, if the raw data value response is less than or equal to the value in column 334, a scaled response value of 0 is assigned to the application inquiry. If the raw data value response is greater than the value in column 334, but less than or equal to the value in column 336, a scaled response value of 1 is assigned to the application inquiry. If the raw data value response is greater than the value in column 336, but less than or equal to the value in column 338, a scaled response value of 2 is assigned to the application inquiry. If the raw data value response is greater than the value in column 338 but less than or equal to the value in column 340, a scaled response value of 3 is assigned to the application inquiry.

Take application inquiry 10 as an example. Referring to FIG. 3A, application 1 received a raw data value response of 0, application 2 received a raw data value response of 18, application 3 received a raw data value response of 10, and application 3 received a raw data value response of 0. For application 1, the raw data value response of 0 is less than or equal to the predetermined value in column 334, so a scaled response value of 0 is assigned thereto. For application 2, the raw data value response of 18 is greater than the value in column 336, but less than or equal to the value in column 338, so a scaled response value of 2 is assigned thereto. For application 3, the raw data response value of 10 is greater than the value in column 336, but less than or equal to the value in column 338, so a scaled response value of 3 is assigned thereto. For application 4, the raw data value response of 0 is less than or equal to the value in column 334, so a scaled response value of 0 is assigned thereto.

Column 342 sets forth the maximum weighted response value or score for each application inquiry. The maximum weighted response value is equal to the product of the weighting for the application inquiry and the maximum scaled response value of 3. Returning to question 10, the maximum score is equal to 15, the product of the application inquiry weighting (5) and the scaled response value 3. Columns 344, 346, 348, and 350 set forth the weighted response value for each application inquiry for applications 1, 2, 3, and 4, respectively. For question 10, application 1 (column 344) has a weighted response value of 0, which is equal to the product of its scaled response value (0) and the application inquiry weighting (5). Application 2 (column 346) has a weighted response value of 10, which is equal to the product of its scaled response value (2) and the application inquiry weighting (5). Application 3 (column 348) has a weighted response value of 15 and application 4 (column 350) has a weighted response value of 0.

At the end of each of columns 342-350 after the list of application inquiries for assessing manageability (inquiries 1-21), the manageability score for each application is set forth in row 352. The manageability score is equal to the sum of the weighted response values for each manageability application inquiry. The maximum manageability score is 177. For application 1 the manageability score is 5, for application 2 it is 141, for application 3 it is 195, and for application 4 it is 79.

At the end of each of column 342-350 after the list of application inquiries for assessing criticality (inquiries 22-36), the criticality score for each application is set forth in row 354. The criticality score is equal to the sum of the weighted response values for each criticality application inquiry. The maximum criticality score is 171. For application 1 the criticality score is 33, for application 2 it is 73, for application 3 it is 126, and for application 4 it is 120.

Following the manageability and criticality inquiries and scores is a revenue bonus calculator for adjusting the criticality score to account for the value of the software application in terms of revenue attributable thereto. Like the manageability and criticality inquiries, a scaling is used to reflect the contribution of revenue to criticality. For the revenue bonus calculator, however, there is no weighting and the range is set forth at the top of columns 358, 360, 362, 364. The scaled response values are set forth below the ranges and in the row with each question. For each of questions 40, 42, and 46, if the determined revenue amount is less than or equal to the value at the top of column 358 ($49,999), there is no additional revenue bonus. If the determined revenue amount if greater than the value in column 358 ($49,999) but less than or equal to the column 360 value ($124,999), a scaled response value of 10 is added. If the determined revenue amount is greater than the column 360 value ($124,999) but less than or equal to the column 362 value ($249,999), a scaled response value of 20 is added. If the determined revenue amount is greater than the column 362 value ($249,999), a scaled response value of 30 is added.

Application 1 is a service application, so question 42 applies. The number of internal or external customers serviced by the application per day (question 41) is multiplied by the average annual customer value (question 42) and expanded to a yearly figure. The associated revenue for application 1 is $0 (100 customers·$0 average annual customer value). Accordingly, no revenue bonus is applied in column 366. Application 2 is also a service application. The associated revenue for it is $930,750 (150 customers per day·$17 average annual customer value·365 days). Accordingly, a revenue bonus of 30 is applied in column 368 since the associated revenue is greater than column 362 value ($249,999). Application 3 is a revenue generating application. For revenue generating applications, the average transactions per hour (question 39) is multiplied by the average value of each transaction (question 40) and expanded to a yearly figure. The associated revenue for application 3 is $6,652,125 (1500 average transactions per hour·$12.15 average value of transaction 365 days). Since this amount is greater than $249,999, a revenue bonus of 30 is applied in column 370.

Application 4 is an account origination application. For account origination applications, the estimated number of new customers activated per month (question 45) is multiplied by the average annual customer value (question 46). The associated revenue for application 4 is $6,822,000 (15,000 new customers per month·$37.90 average annual customer value·12 months). Since this amount is greater than $249,999, a revenue bonus of 30 is applied in column 372.

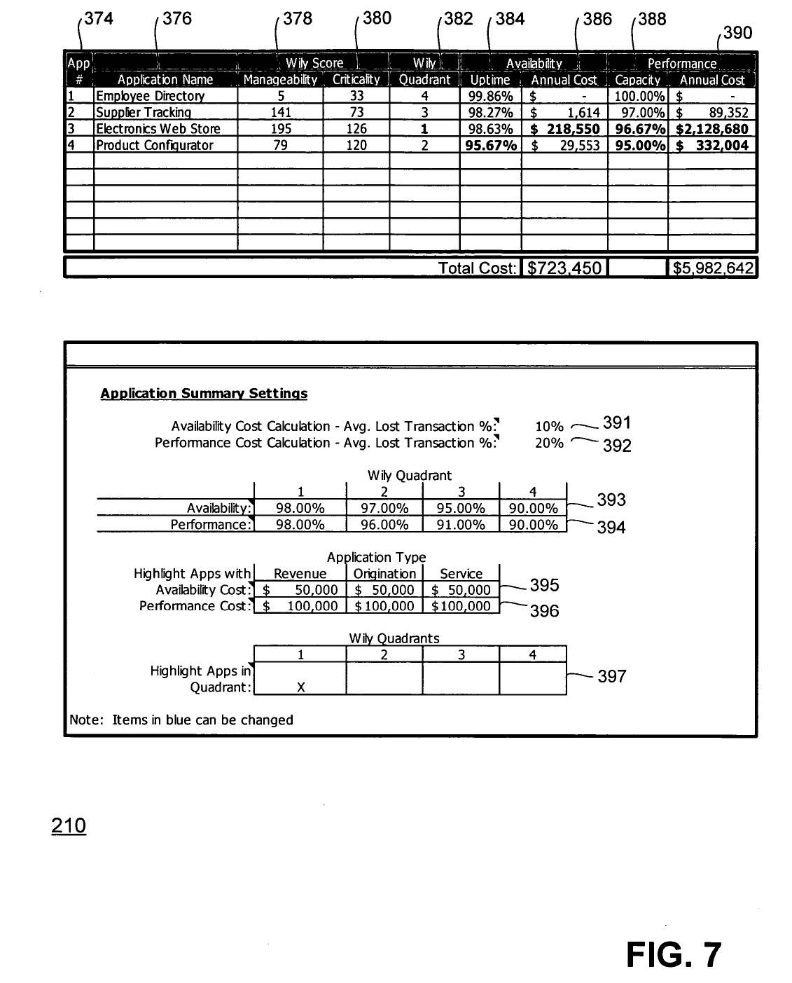

FIG. 7 depicts one embodiment of application summary component 210. In this embodiment, component 210 is implemented as one or more spreadsheets but other embodiments can utilize other suitable implementations. Each application is listed in columns 374 and 376 by name and number respectively. The manageability score for each application is listed in column 378 and the criticality score is listed in column 380.

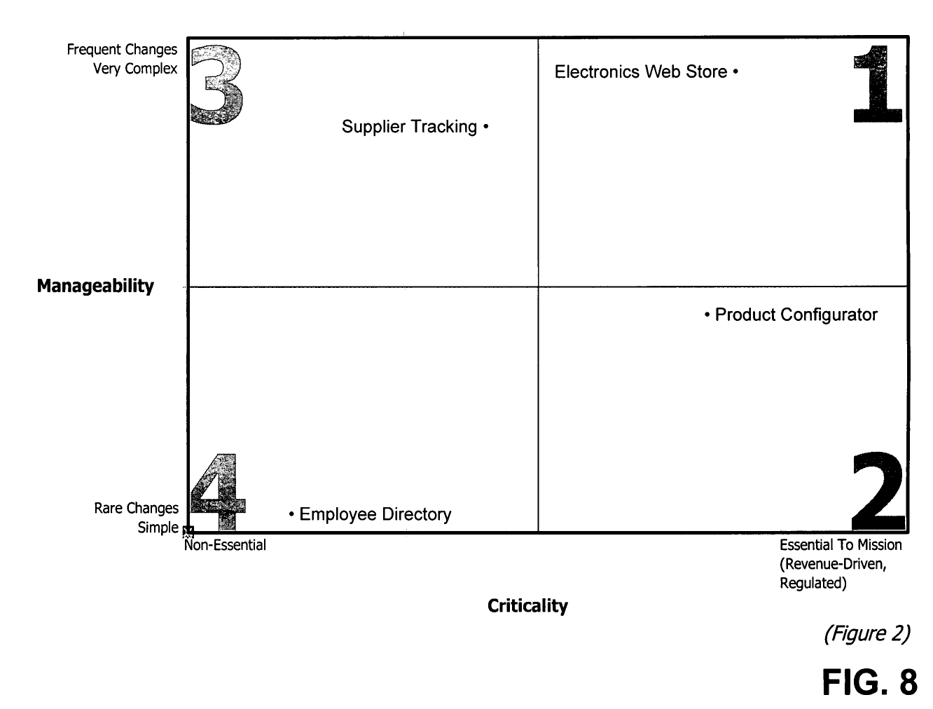

Based on the manageability score and criticality score, a quadrant for the application is selected. Column 382 lists the quadrant for each application. FIG. 8 depicts one implementation of quadrant chart 212 in accordance with one embodiment. Quadrant chart 212 can graphically depict the relative manageability and criticality of an application implementation. Manageability is reflected on the vertical axis of the chart and criticality is reflected on the horizontal axis. Quadrant 1 corresponds to applications having a high manageability score and a high criticality score. Quadrant 2 corresponds to applications having a low manageability score and a high criticality score. Quadrant 3 corresponds to applications having a high manageability score and a low criticality score. Quadrant 4 corresponds to applications having a low manageability score and a low criticality score. Various cutoff points for low/high manageability and low/high criticality can be selected based on the needs of a particular implementation. For example, in the embodiments heretofore described, the cutoff point between quadrants 4 and 2 or quadrants 3 and 1 for manageability can be selected at 110. Those applications with manageability scores of 110 or less will either be in quadrant 4 or 2 while those applications with manageability scores of over 110 will either be in quadrant 3 or 1. Those applications with criticality scores of 90 or less will either be in quadrant 3 or 4 while those applications with criticality scores of over 90 will either be in quadrant 1 or 2. In other embodiments, different cutoff points can be used for manageability and criticality and the points need not be the same.

Looking back at FIG. 7, application 1 has a manageability score of 5 and a criticality score of 33, placing it into quadrant 4. Application 2 has a manageability score 141 and a criticality score of 73, placing it into quadrant 3. Application 3 has a manageability score of 195 and a criticality score of 126, placing it into quadrant 1. Application 4 has a manageability score of 79 and a criticality score of 120, placing it into quadrant 2. These placements are reflected in quadrant chart 212 where each of the applications has been plotted in accordance with its manageability and criticality scores.

Application summary component 210 includes additional information beyond the manageability scores, criticality scores, and quadrants. This information is set forth in columns 384-390 and is derived from the application risk exposure inquiries (37-46). Column 384 sets forth the uptime availability percentage of each application. This value is calculated from questions 37 and 38 which determine the planned downtime of the application and the unplanned downtime of the application, respectively. Using the total downtime of the application, the uptime availability percentage is calculated. Application 1 has an uptime percentage of 99.86%, application 2 has an uptime percentage of 98.27%, application 3 has an uptime percentage of 98.63%, and application 4 has an uptime percentage of 95.67%.

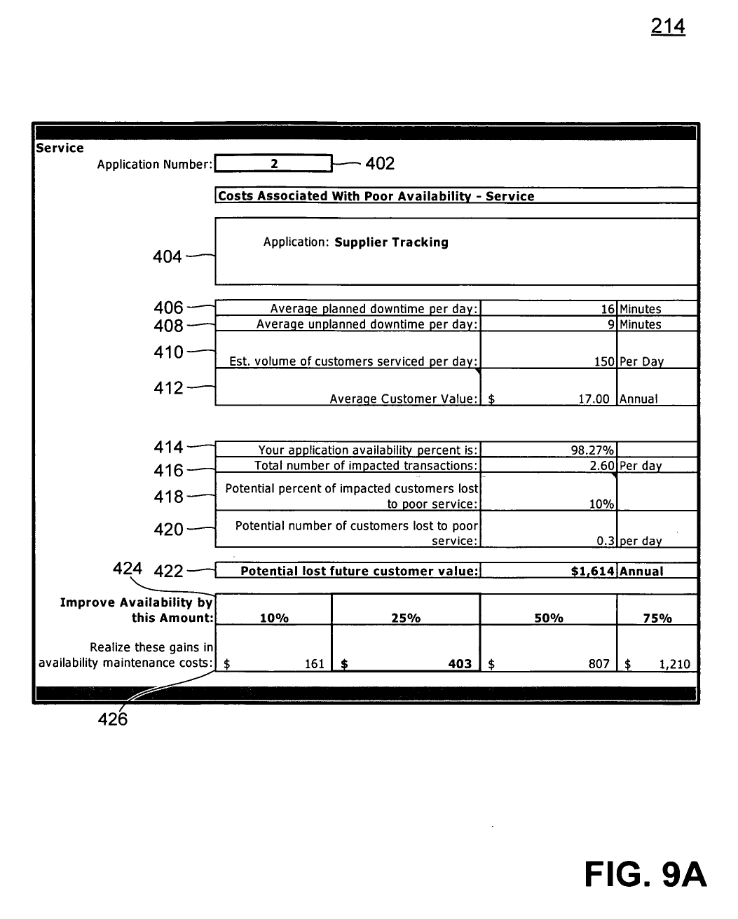

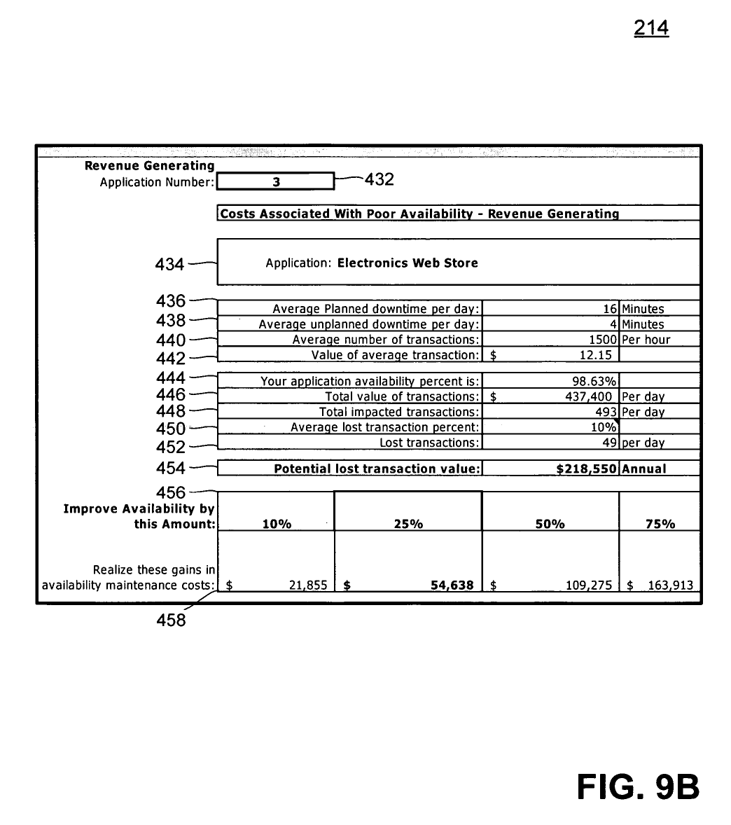

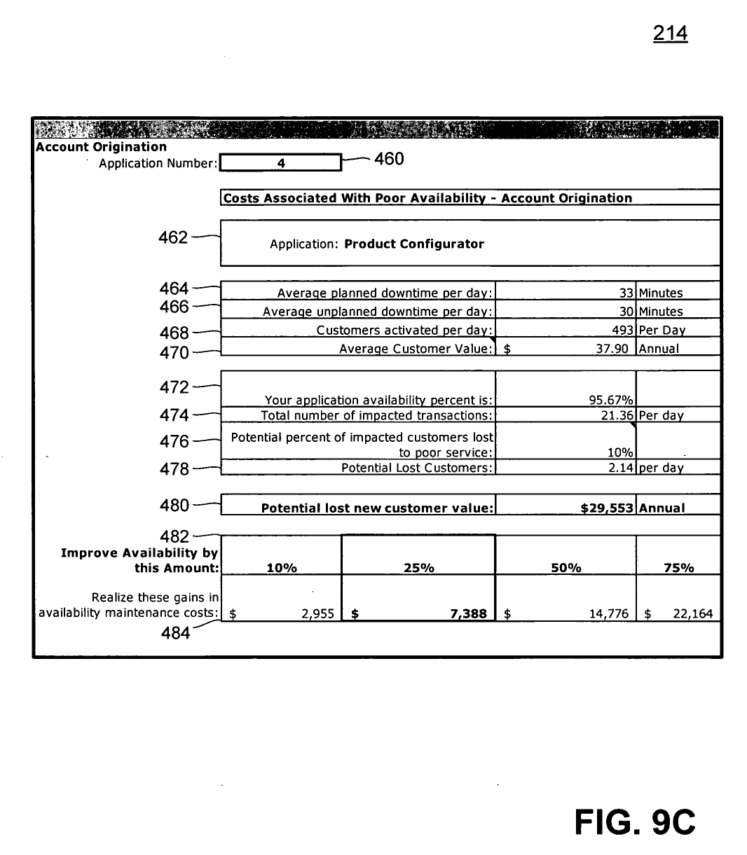

In addition to the uptime availability percentage, the annual cost of lost uptime (downtime) for the application is provided in column 386. For service applications (e.g., applications 1 and 2), this value is determined from the total downtime (questions 37 and 38), the number of customers serviced by the application per day (question 41), and the average annual customer value. Recognizing that not every impacted transaction due to a lack of availability will result in a lost transaction, a value representing the percentage of customers that will actually be lost due to poor availability is factored into the equation. For example, it can be assumed that 10% of impacted customers due to poor performance will be lost and that 90% of impacted customers will try again and thus, not lead to lost transactions. Of course, these assumptions can be modified in any given implementation. More details regarding the determination of the cost of lost uptime for service applications will be discussed in regards to FIG. 9A.

For revenue generating applications (e.g., application 3), the annual cost of lost uptime for the application is determined from the total downtime, the average number of transactions per hour, and the average value of each transaction. Again, recognizing that not every impacted transaction due to a lack of availability will result in a lost transaction, an average lost transaction percentage can be factored into the determination. This percentage can represent the average percentage of impacted transactions that will be lost due to poor availability. More details regarding the determination of the cost of lost uptime for revenue generating applications will be discussed with regard to FIG. 9B.

For account origination applications (e.g., application 4), the annual cost of lost uptime for the application is determined from the total downtime, the estimated number of new users activated per month, and the average annual value of each customer. Recognizing that not every impacted transaction due to a lack of availability will result in a lost customer, a lost customer percentage due to impacted transactions can be factored into the determination. This percentage can represent the potential percent of customers that will be lost due to a user not trying to execute the activation again after having it fail during an unavailable period. More details regarding the determination of the cost of lost uptime for account origination applications will be discussed with regard to FIG. 9C.

Column 388 sets forth the performance capacity percentage of the application. This figure represents the ratio of the actual capacity (question 44) of an application to the desired capacity (question 42) of the application. The percentage is calculated by dividing the actual capacity by the desired capacity. For application 1, the performance capacity percentage is 100% reflecting that the actual capacity is equal to the desired capacity. For application 2, the percentage is 97%. For application 3, it is 96.67% and for application 4, it is 95%.

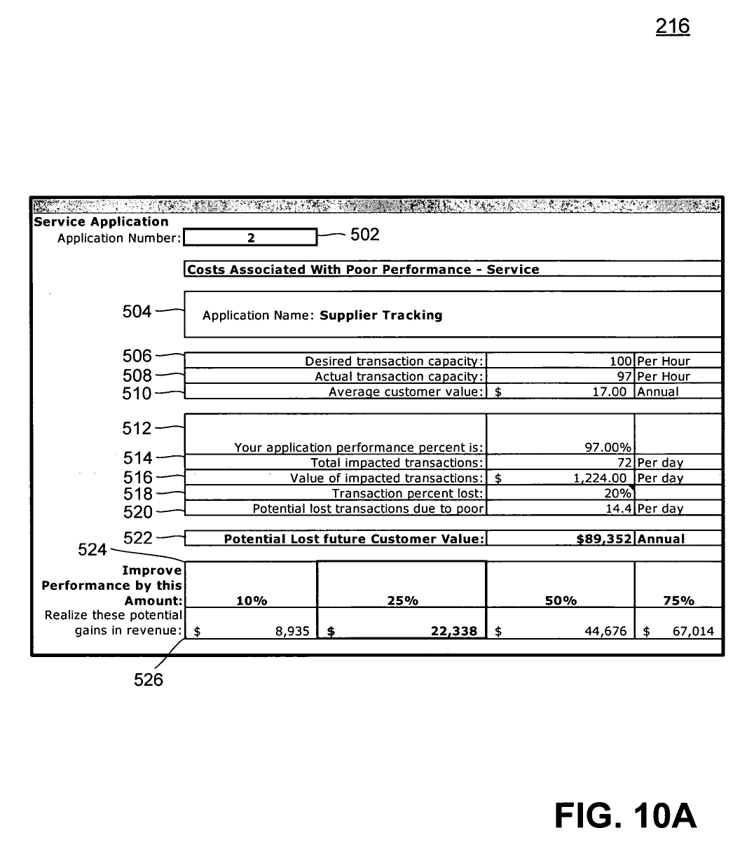

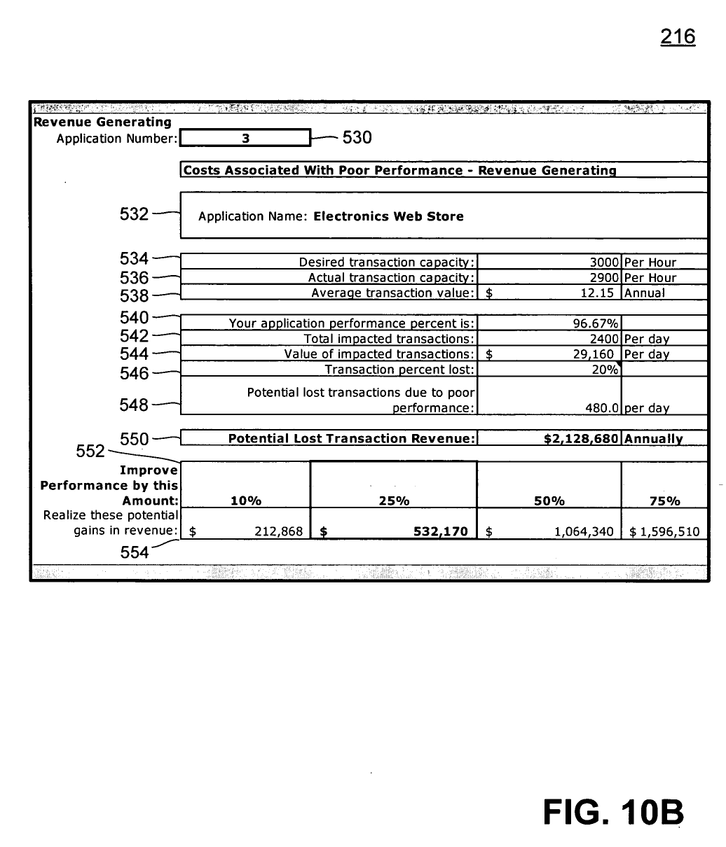

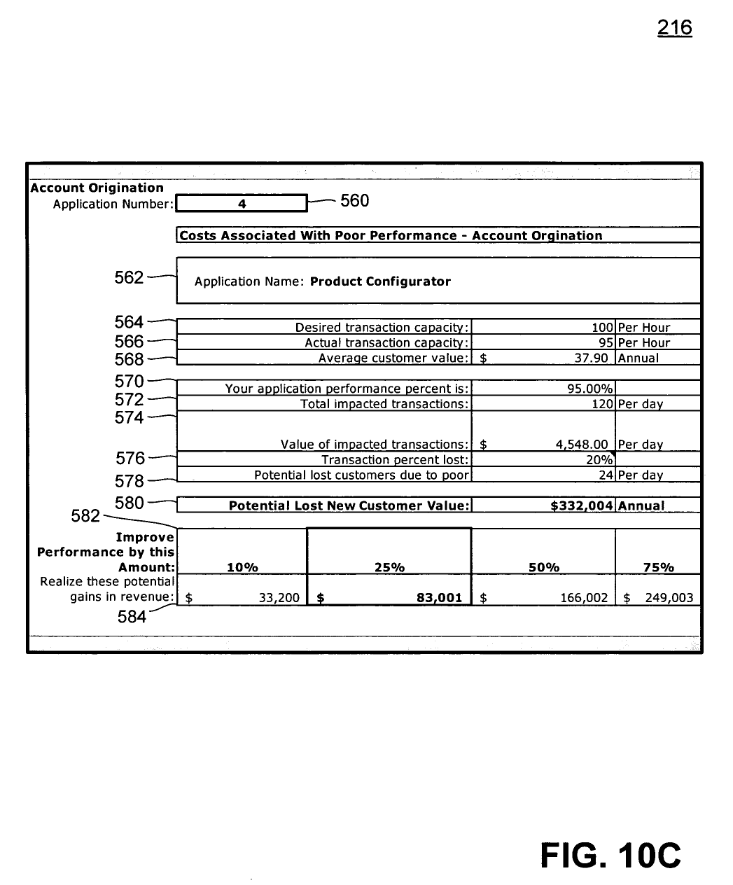

Following the performance capacity percentage, the annual cost of poor performance (insufficient capacity) is set forth in column 390. For service applications, this cost is determined from the performance capacity percentage and the average customer value. A percentage of impacted transactions due to poor performance that result in lost customers is factored into the equation to recognize that not every impacted transaction will result in a lost transaction or customer. The actual percentage used can vary by implementation to suit the needs or particular characteristics of a particular application or business. More details regarding the calculation of cost of poor performance will be discussed with respect to FIG. 10A.

For revenue generating applications, the annual cost of poor performance is determined from the application performance capacity percentage and the average transaction value. Again, a percentage of impacted transactions that are lost due to poor performance is factored into the equation to recognize that not every impacted transaction will result in a lost transaction. For account origination applications, the annual cost of poor performance is determined from the performance capacity percentage, the average annual customer value, and a percentage of impacted transactions that lead to lost customers.

For account origination applications, the annual cost of poor performance is determined from the application performance capacity percentage and the average annual customer value. A percentage of impacted transactions that lead to lost customers is factored into the equation to recognize that not every impacted transaction will lead to a lost customer. Thus, the annual cost of poor performance for account origination applications is determined from the capacity percentage, the average annual customer value, and the percentage of impacted transactions that lead to lost customers.

FIG. 7 also depicts an application summary settings portion of application summary component 210. This portion allows customization of the display of that portion previously described and depicted at the top of FIG. 7. Additionally, the selection of values for determining the annual cost of lack of availability and the annual cost of poor performance for columns 386 and 390 is provided. Row 391 allows a user of the tool to enter an average lost transaction percent for determining availability costs (column 386). The lost transaction percentage is the percentage of impacted transactions that result in an actual lost transaction or customer. This percentage will be used in the computation for each application in one embodiment. In other embodiments, individual lost transaction percentages can be used for one or more of the applications. Row 392 allows a user to enter an average lost transaction percentage for determining performance costs for each application (column 390). In other embodiments, individual lost transaction percentages for determining performance costs can be used for one or more of the applications.

Rows 393 and 394 allow a user of the tool to customize the display of FIG. 7. Threshold availability percentages can be entered in row 393 for each quadrant and threshold performance capacity percentages can be entered in row 394 for each quadrant. Any application in a quadrant having an availability percentage or performance capacity percentage below the corresponding threshold value will have that value highlighted in column 384 or 388. As shown, the availability percentage of application 4 is highlighted in column 384 because the percentage 95.67% is below the threshold value of 97% for quadrant 2. The performance capacity percentage of applications 3 and 4 are highlighted because their percentages are lower than the threshold values for quadrants 1 and 2, respectively.

Row 395 allows a user to enter threshold availability costs for revenue, account origination, and service applications and row 396 allows a user to enter threshold performance costs for the same. If the cost of either value for an application is above the threshold level, the cost will be highlighted. As shown, the annual cost of availability for application 3 is highlighted because it is above the threshold value of $50,000 and the annual costs of performance for applications 3 and 4 are highlighted because they are above the threshold value of $100,000. Although the thresholds for each type of application are the same, different values can be used in other embodiments. Additionally, individual values can be used for one or more applications. Row 397 allows a user to select a quadrant to be highlighted. In the provided example, quadrant 1 is selected such that it is highlighted in column 382.

FIGS. 9A-9C depict a cost of availability summary component 214 in accordance with one embodiment. The cost of availability summary component can depict and optionally perform the calculations for determining uptime percentages (column 360) and annual cost (column 362) as depicted in application summary component 3D. In one embodiment, these values are calculated by application summary component 210.

FIG. 9A depicts a portion of cost of availability component 214 for a service application. Application number 2 has been entered in box 402 so as to display the relevant data for application 2. The name of the application is set forth in box 404. The average planned downtime (question 37) is set forth in row 406. In this embodiment, the value is presented as a per minute figure. The average unplanned downtime (question 38) is set forth in row 408 as a per minute figure. The estimated number of customers serviced per day (question 41) is set forth in row 410 and the average annual customer value (question 42) is set forth in row 412. The information in rows 404-412 can be retrieved or linked to data collection component 202. The application availability percent is set forth in row 414. This is the same value presented in column 384 of FIG. 7. The total number of impacted transactions per day is set forth in row 416. This value is calculated by taking the estimated number of customers serviced per day (row 410) and adjusting the number to a per minute figure. The estimated number of customers serviced per minute is then multiplied by the downtime minutes per day to arrive at the total number of impacted transactions per day.

Row 418 sets forth the potential percentage of impacted customers lost to poor availability. As previously discussed, this percentage reflects the fact that not all impacted customers will be lost customers. Some impacted customers will retry the application at a later time and have success while others will be lost due the temporary unavailability. In the embodiment of FIG. 9A, it is established that only 10% of impacted customers will be lost. Other percentages can be used. The value of row 418 can be drawn from row 391 of summary component 210 in one embodiment. The potential number of customers lost to poor availability or service is set forth in row 420 as is calculated by taking the product of the total number of impacted transactions (row 416) and the potential percentage of impacted customers lost to poor availability or service (row 418). In row 422, the potential lost future customer value is set forth. This value is calculated by multiplying the potential number of customers lost to poor service per year (row 420 multiplied by 365) by the average annual customer value (row 412). In one embodiment the values in row 414, 416, and 420 are calculated by application summary component 210 and in others they are calculated by availability summary component 214.

Rows 424 and 426 allow a user to view how an increase in availability of the application will affect the availability maintenance costs. In row 424, various increases in availability percentage are shown. Although values of 10%, 25%, 50%, and 75% are shown, other percentages can be set forth in other implementations. In row 426, the corresponding gains in availability maintenance costs are set forth. The gains are calculated by multiplying the potential lost future customer value (row 422) by the improved availability percentage (row 424). In this example, if availability is increased by 10%, the gains in availability maintenance costs are $161. If availability is increased by 25%, the gains in availability maintenance costs are $403. If availability is increased by 50%, the gains in availability maintenance costs are $807. If availability is increased by 75%, the gains in availability maintenance costs are $1210.

FIG. 9B depicts a portion of cost of availability component 214 for a revenue generating application. Application number 3 has been entered in box 432 so as to display the relevant data for application 3. The name of the application is set forth in box 434. The average planned downtime (question 37) is set forth in row 436. In this embodiment, the value is presented as a per minute figure. The average unplanned downtime (question 38) is set forth in row 438 as a per minute figure. The average number of transactions per hour (question 39) is set forth in row 440 and the value of an average transaction (question 40) is set forth in row 442. The information in rows 434-442 can be retrieved or linked to data collection component 202. The application availability percent is set forth in row 444. The total value of transactions per day is set forth in row 446. The total number of impacted transactions per day is set forth in row 448. This value is calculated by first taking the average number of transactions per hour (row 440) and adjusting the number to a daily figure. The average number of transactions per day is then multiplied by the downtime minutes per day to arrive at the total number of impacted transactions per day.

Row 450 sets forth the average lost transaction percentage. This percentage reflects the fact that not all impacted transactions will be lost. Some customers will retry the impacted transaction at a later time and have success while others will be lost due to the temporary unavailability. This value can be retrieved from summary component 210 in one embodiment. The potential number of lost transactions per day due to application unavailability is set forth in row 452. It is calculated by taking the product of the total number of impacted transactions (row 448) and the average lost transaction percentage (row 450). In row 454, the potential lost transaction value is set forth. This value is calculated by multiplying the number of lost transactions per day (row 452 multiplied by 365) by the value of the average transaction (row 442). In one embodiment, the values in rows 444, 446, 448, and 452 are calculated by component 214 and in others they are calculated by component 210.

Rows 456 and 458 allow a user to view how an increase in availability of the application will affect the availability maintenance costs as previously described in FIG. 9A. The gains are calculated by multiplying the potential lost transaction value (row 454) by the improvement in availability (row 458). In this example, if availability is increased by 10%, the gains in availability maintenance costs are $21,855. If availability is increased by 25%, the gains in availability maintenance costs are $54,638. If availability is increased by 50%, the gains in availability maintenance costs are $109,275. If availability is increased by 75%, the gains in availability maintenance costs are $163,913.

FIG. 9C depicts a portion of cost of availability summary component 212 for an account origination application. Application number 4 has been entered in box 460 so as to display the relevant data for application 4. The name of the application is set forth in box 462. The average planned downtime (question 37) is set forth in row 464. The average unplanned downtime (question 38) is set forth in row 438. The average number of customers activated per day (question 45 adjusted to daily figure) is set forth in row 468 and the average annual customer value (question 46) is set forth in row 470. The application availability percent is set forth in row 444. The total number of impacted transactions per day is set forth in row 474.

Row 476 sets forth the potential percentage of impacted customers that will be lost due to the poor service or availability. The potential number of lost customers per day is set forth in row 478. In row 480, the potential lost new customer value is set forth. This value is calculated by multiplying the number of potential lost customers per day by the average customer value per day.

Rows 456 and 458 allow a user to view how an increase in availability of the application will affect the availability maintenance costs as previously described in FIG. 9A.

FIGS. 10A-10C depict a cost of performance summary component 216 in accordance with one embodiment. The cost of performance summary component can depict and optionally perform the calculations for determining performance capacity (column 364) and the annual cost (column 366) attributable to poor performance as depicted in application summary component 210. In one embodiment, application summary component 210 calculates these values.

FIG. 10A depicts a portion of cost of performance summary component 216 for a service application. Application number 2 has been entered in box 502 so as to display the relevant data for application 2. The name of the application is set forth in box 504. The desired transaction capacity (question 43) is set forth in row 506. The actual transaction capacity (question 44) is set forth in row 508. The average customer value (question 42) is set forth in row 510. The information in rows 504-510 can be retrieved or limited to data collection component 202. The application performance percentage is set forth in row 512. This is the same value presented in column 388 of FIG. 7. The total number of impacted transactions per day is set forth in row 514. This value is calculated by taking the difference between the desired transaction capacity and the actual transaction capacity (100−97) and adjusting the number to a daily figure.

Row 516 sets forth the value of impacted transactions per day, calculated by multiplying the total number of impacted transactions per day by the average annual customer value. Row 518 sets forth the percentage of impacted transactions that are lost due to poor performance or insufficient capacity. As previously described, this percentage reflects the fact that not all impacted transactions or customers will be lost customers. Some impacted customers will retry the application at a later time and have success while others will not and thus, be lost due the lack of capacity. 20% of impacted transactions are lost in this exemplary embodiment. Other percentages can be used. The potential number of lost transactions due to insufficient capacity is set forth in row 520 and is calculated by taking the product of the total number of impacted transactions (row 514) and the percentage of impacted transactions that are lost (row 518). In row 522, the potential lost future customer value is set forth. This value is calculated by multiplying the potential number of lost transactions due to insufficient capacity (row 520 multiplied by 365) by the average annual customer value (row 510). In one embodiment, the values in rows 512, 514, 516, 520, and 522 are calculated by performance summary component 216 and in other, they are calculated by summary component 214.

Rows 524 and 526 allow a user to view the potential gains in revenue attributable to certain levels of improved performance. Row 524 sets forth various percentages of improved performance and row 526 sets forth the corresponding gains in revenue. Although values of 10%, 25%, 50%, and 75% in row 524 are shown, other percentages can be used in other implementations. The gains are calculated by multiplying the potential lost fuiture customer value (row 522) by the improved performance percentage (row 524). In this example, if performance is increased by 10%, the potential gains in revenue are $8935. If performance is increased by 25%, the potential gains in revenue are $22,338. If performance is increased by 50%, the potential gains in revenue are $44,676. If availability is increased by 75%, the potential gains in revenue are $67,014.

FIG. 10B depicts a portion of cost of performance summary component 214 for a revenue generating application. Application number 3 has been entered in box 530 so as to display the relevant data for application 3. The name of the application is set forth in box 532. The desired transaction capacity (question 43) is set forth in row 534. The actual transaction capacity (question 44) is set forth in row 536. The average transaction value (question 42) is set forth in row 538. The application performance percentage is set forth in row 540. This is the same value presented in column 388 of FIG. 7 and is the percentage of the desired transaction capacity that the actual transaction capacity is. The total number of impacted transactions per day is set forth in row 542. This value is calculated by taking the difference between the desired transaction capacity and the actual transaction capacity (3000−2900) and adjusting the number to a daily figure.

Row 544 sets forth the value of impacted transactions per day, calculated by multiplying the total number of impacted transactions per day by the average transaction value. Row 546 sets forth the percentage of impacted transactions that are lost due to poor performance or insufficient capacity. The potential number of lost transactions due to poor performance is set forth in row 548 and is calculated by taking the product of the total number of impacted transactions (row 542) and the percentage of impacted transactions that are lost (row 546). In row 550, the potential lost transaction value is set forth. This value is calculated by multiplying the potential number of lost transactions due to poor performance (row 548 multiplied by 365) by the average transaction value (row 538).

Rows 552 and 554 allow a user to view the potential gains in revenue attributable to certain levels of improved performance. These rows are implemented in the same fashion as rows 524 and 526 of FIG. 10A.

FIG. 10C depicts a portion of cost of performance summary component 214 for an account origination application. Application number 4 has been entered in box 560 so as to display the relevant data for application 4. The name of the application is set forth in box 562. The desired transaction capacity (question 43) is set forth in row 564 and the actual transaction capacity (question 44) in row 566. The average customer value (question 46) is set forth in row 568. The application performance percentage is set forth in row 570. This is the same value presented in column 364 of FIG. 7 and is the percentage of the desired transaction capacity that the actual transaction capacity is. The total number of impacted transactions per day is set forth in row 572. This value is calculated by taking the difference between the desired transaction capacity and the actual transaction capacity (100−95) and adjusting the number to a daily figure.

Row 574 sets forth the value of impacted transactions per day, calculated by multiplying the total number of impacted transactions per day by the average customer value. Row 576 sets forth the percentage of impacted transactions that are lost due to poor performance or insufficient capacity. The potential number of customers lost due to poor performance is set forth in row 578 and is calculated by taking the product of the total number of impacted transactions (row 572) and the percentage of impacted transactions that are lost (row 576). In row 580, the potential lost new customer value is set forth. This value is calculated by multiplying the potential number of customers lost due to poor performance by the average customer value (row 568). Rows 582 and 584 allow a user to view the potential gains in revenue attributable to certain levels of improved performance. These rows are implemented in the same fashion as rows 524 and 526 of FIG. 10A.

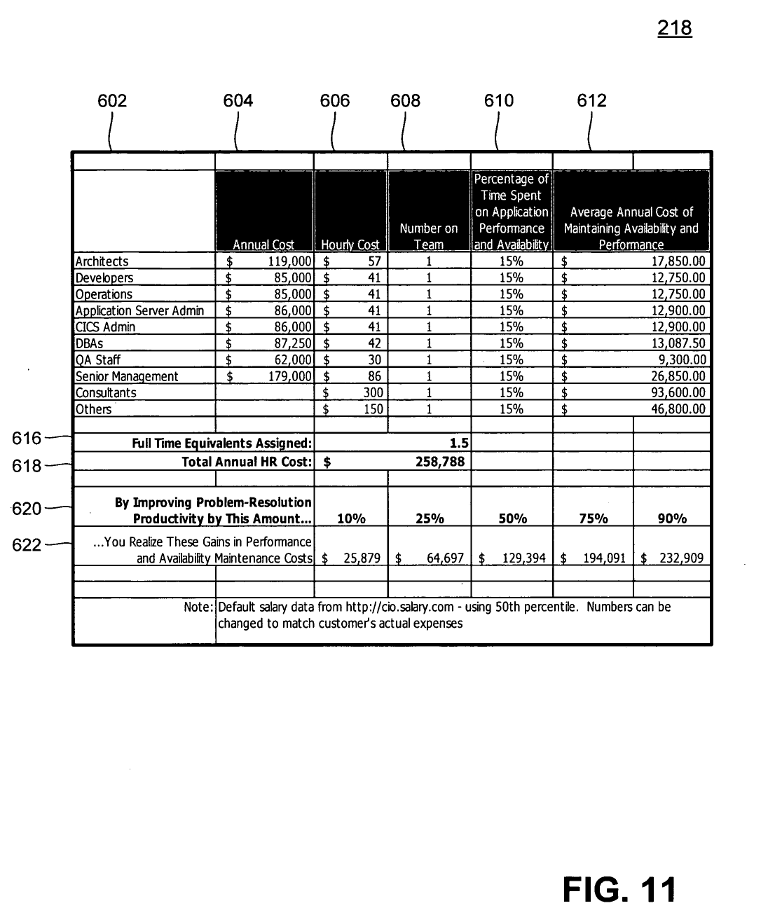

FIG. 11 provides an information technology (IT) resource summary. The summary allows a user to view the human resource costs associated with application availability and performance. A list of personnel types is provided in column 602. Additional personnel types can be listed in lieu of or in addition to those presented in the exemplary embodiment of FIG. 11. Architects, developers, operations personnel, application server administrators, CICS administrators, database administrators, QA staff, senior management, consultants, and a catch-all others category are provided. The annual cost of each type of personnel is provided, if appropriate, in column 604 and the hourly rate of each type is provided in column 606. The number of each type of personnel that is on a team for the application is listed in column 608 and the percentage of time they spend on application performance and availability is listed in column 610. These values are used to compute the average annual cost of each type of personnel.

Using the numbers of each type of personnel on the team and the percentage of time they spend on the availability and performance a full time equivalents (FTE) figure is computed. This figure in row 616 is a representation of the equivalent number of full time individuals working on availability and performance. In this example, that figure is 1.5 (10 people at 15% each). The total annual human resources cost, equal to the sum of the costs in column 612, is set forth in row 618.

A table for displaying improvements in availability and performance costs based on improvements in problem-resolution is provided by rows 620 and 622. In row 622 select percentage improvements in problem-resolution productivity are set forth. These percentages represent improvements in the amount of time that IT personnel must devote to application availability and/or performance. Although select percentages are presented, additional percentages can be used in lieu of or in addition to those listed. In row 622, corresponding gains in performance and availability costs are listed.

Having assessed the manageability and criticality of various software applications, certain applications can be selected (step 124 of FIG. 1) for performance profiling or analysis (step 126). The selection of one or more applications can be based on rankings created at step 118 of FIG. 1. In one embodiment, one or more applications are selected automatically by tool 200 for analysis. If the manageability score and criticality score for an application are each above a predetermined threshold value, they can be identified for analysis. In other embodiments, applications having a manageability or criticality score above a predetermined threshold value can be selected. For example, an application that is determined to require large amounts of resources to manage but which is not very critical to an organization can be selected. In one embodiment, a user can select particular applications for analysis after tool 200 creates the application rankings.

In one embodiment, the performance profiling or analysis performed at step 126 can include tracing transactions to identify which components of a transaction may be executing too slow. In one embodiment, the system traces transactions in order to identify those transactions that have an execution time greater than a threshold time. A transaction is a method, process, procedure, function, thread, set of instructions, etc. for performing a task. In one embodiment, the system is used to monitor methods in a Java environment. In that embodiment, a transaction is a method invocation in a running software system that enters the Java Virtual Machine (“JVM⇄) and exits the JVM (and all that it calls). In one embodiment, the system described below can initiate transaction tracing on one, some, or all transactions managed by the system. A user, or another entity, can specify a threshold trace period. All transactions whose root level execution time exceeds the threshold trace period are reported. In one embodiment, the reporting will be performed by a Graphical User Interface (“GUI⇄) that lists all transactions exceeding the specified threshold. For each listed transaction, a visualization can be provided that enables the user to immediately understand where time was being spent in the traced transaction. Although the implementation described below is based on a Java application, embodiments can be used with other programming languages, paradigms and/or environments.

There are many implementations possible in accordance with embodiments. One example is an implementation within an application performance management tool. One embodiment of such an application performance management tool monitors performance of an application by having access to the source code and modifying that source code. Sometimes, however, the source code is not available. Another type of tool performs application performance management without requiring access to or modification of the application's source code. Rather, the tool instruments the application's object code (also called bytecode). FIG. 12 depicts an exemplar process for modifying an application's bytecode. FIG. 12 shows Application 702, Probe Builder 704, Application 706 and Agent 708. Application 6 includes probes, which will be discussed in more detail below. Application 702 is the Java application before the probes are added. In embodiments that use programming language other than Java, Application 702 can be a different type of application.

Probe Builder 4 instruments (e.g. modifies) the bytecode for Application 702 to add probes and additional code to Application 702 in order to create Application 706. The probes measure specific pieces of information about the application without changing the application's business logic. Probe Builder 4 also installs Agent 8 on the same machine as Application 706. Once the probes have been installed in the bytecode, the Java application is referred to as a managed application. More information about instrumenting byte code can be found in U.S. Pat. No. 6,260,187 “System For Modifying Object Oriented Code” by Lewis K. Cirne, incorporated herein by reference in its entirety.

One embodiment instruments bytecode by adding new code that activates a tracing mechanism when a method starts and terminates the tracing mechanism when the method completes. To better explain this concept consider the following example pseudo code for a method called “exampleMethod.” This method receives an integer parameter, adds 1 to the integer parameter, and returns the sum:

```
public int
exampleMethod(int x)
    {
    return x + 1;
    }
```

One embodiment of the present invention will instrument this code, conceptually, by including a call to a tracer method, grouping the original instructions from the method in a “try” block and adding a “finally” block with a code that stops the tracer:

| public int | |
|---|---|
| exampleMethod(int x) | |
| { | |
| IMethodTracer tracer = AMethodTracer.loadTracer( | |
| “com.introscope.agenttrace.MethodTimer”, | |
| this, | |
| “com.wily.example.ExampleApp”, | |
| “exampleMethod”, | |
| “name=Example Stat”); | |
| try { | |
| return x + 1; | |
| } finally | { |
| | tracer.finishTrace( ); |
| | } |
| } | |

IMethodTracer is an interface that defines a tracer for profiling. AMethodTracer is an abstract class that implements IMethodTracer. IMethodTracer includes the methods startTrace and finishTrace. AMethodTracer includes the methods startTrace, finishTrace, dostartTrace and dofinishTrace. The method startTrace is called to start a tracer, perform error handling and perform setup for starting the tracer. The actual tracer is started by the method doStartTrace, which is called by startTrace. The method finishTrace is called to stop the tracer and perform error handling. The method finishTrace calls doFinishTrace to actually stop the tracer. Within AMethodTracer, startTrace and finishTracer are final and void methods; and doStartTrace and doFinishTrace are protected, abstract and void methods. Thus, the methods doStartTrace and do FinishTrace must be implemented in subclasses of AMethodTracer. Each of the subclasses of AMethodTracer implement the actual tracers. The method loadTracer is a static method that calls startTrace and includes five parameters. The first parameter, “com.introscope . . . ” is the name of the class that is intended to be instantiated that implements the tracer. The second parameter, “this” is the object being traced. The third parameter “com.wily.example . . . ” is the name of the class that the current instruction is inside of. The fourth parameter, “exampleMethod” is the name of the method the current instruction is inside of. The fifth parameter, “name=. . . ” is the name to record the statistics under. The original instruction (return×+1) is placed inside a “try” block. The code for stopping the tracer (a call to the static method tracer.finishTrace) is put within the finally block.

The above example shows source code being instrumented. In one embodiment, the present invention doesn't actually modify source code. Rather, the present invention modifies object code. The source code examples above are used for illustration to explain the concept of embodiments. The object code is modified conceptually in the same manner that source code modifications are explained above. That is, the object code is modified to add the functionality of the “try” block and “finally” block. More information about such object code modification can be found in U.S. patent application Ser. No. 09/795,901, “Adding Functionality To Existing Code At Exits,” filed on Feb. 28, 2001, incorporated herein by reference in its entirety. In another embodiment, the source code can be modified as explained above.

FIG. 13 is a conceptual view of the components of the application performance management tool. In addition to managed Application 706 with probes 712 and 714, FIG. 13 also depicts Enterprise Manager 720, database 722, workstation 724 and workstation 726. As a managed application runs, probes (e.g. 712 and/or 714) relay data to Agent 708. Agent 708 then collects and summarizes the data, and sends it to Enterprise Manager 720. Enterprise Manager 720 receives performance data from managed applications via Agent 708, runs requested calculations, makes performance data available to workstations (e.g. 724 and 726) and optionally sends performance data to database 722 for later analysis. The workstations (e.g. 724 and 726) are the graphical user interface for viewing performance data. The workstations are used to create custom views of performance data which can be monitored by a human operator. In one embodiment, the workstations consist of two main windows: a console and an explorer. The console displays performance data in a set of customizable views. The explorer depicts alerts and calculators that filter performance data so that the data can be viewed in a meaningful way. The elements of the workstation that organize, manipulate, filter and display performance data include actions, alerts, calculators, dashboards, persistent collections, metric groupings, comparisons, smart triggers and SNMP collections.

In one embodiment of the system of FIG. 13, each of the components are running on different machines. That is, workstation 726 is on a first computing device, workstation 724 is on a second computing device, Enterprise Manager 720 is on a third computing device, and managed Application 706 is running on a fourth computing device. In another embodiment, two or more (or all) of the components are operating on the same computing device. For example, managed application 6 and Agent 8 may be on a first computing device, Enterprise Manager 720 on a second computing device and a workstation on a third computing device. Alternatively, all of the components of Figure two can run on the same computing device. Any or all of these computing devices can be any of various different types of computing devices, including personal computers, minicomputers, mainframes, servers, handheld computing devices, mobile computing devices, etc. Typically, these computing devices will include one or more processors in communication with one or more processor readable storage devices, communication interfaces, peripheral devices, etc. Examples of the storage devices include RAM, ROM, hard disk drives, floppy disk drives, CD ROMS, DVDs, flash memory, etc. Examples of peripherals include printers, monitors, keyboards, pointing devices, etc. Examples of communication interfaces include network cards, modems, wireless transmitters/receivers, etc. The system running the managed application can include a web server/application server. The system running the managed application may also be part of a network, including a LAN, a WAN, the Internet, etc. In some embodiments, all or part of the invention is implemented in software that is stored on one or more processor readable storage devices and is used to program one or more processors.

In one embodiment, a user of the system in FIG. 13 can initiate transaction tracing on all or some of the Agents managed by an Enterprise Manager by specifying a threshold trace period. All transactions inside an Agent whose execution time exceeds this threshold level will be traced and reported to the Enterprise Manager 720, which will route the information to the appropriate workstations who have registered interest in the trace information. The workstations will present a GUI that lists all transactions exceeding the threshold. For each listed transaction, a visualization that enables a user to immediately understand where time was being spent in the traced transaction can be provided.

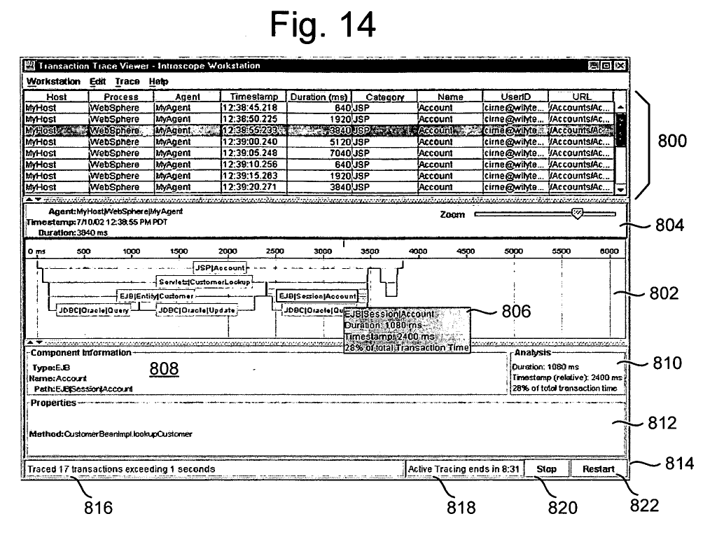

FIG. 14 provides one example of a graphical user interface to be used for reporting transactions in accordance with embodiments. The GUI includes a transaction trace table 800 which lists all of the transactions that have satisfied the filter (e.g. execution time greater than the threshold). Because the number of rows on the table may be bigger than the allotted space, the transaction trace table 800 can scroll. Table 1, below, provides a description of each of the columns of transaction trace table 800.

TABLE 1

| Column Header | Value |
|---|---|
| Host | Host that the traced Agent is running on |
| Process | Agent Process name |
| Agent | Agent ID |
| TimeStamp | TimeStamp (in Agent's JVM's clock) of the |
| (HH:MM:SS.DDD) | initiation of the Trace Instance's root entry point |
| Category | Type of component being invoked at the root level |
| | of the Trace Instance. This maps to the first segment |
| | of the component's relative blame stack: Examples |
| | include Servlets, JSP, EJB, JNDI, JDBC, etc. |
| Name | Name of the component being invoked. This maps |
| | to the last segment of the blamed component's |
| | metric path. (e.g. for “Servlets\|MyServlet”, |
| | Category would be Servlets, and Name would be |
| | MyServlet). |
| URL | If the root level component is a Servlet or JSP, the |
| | URL passed to the Servlet/JSP to invoke this Trace |
| | Instance. If the application server provides services |
| | to see the externally visible URL (which may differ |
| | from the converted URL passed to the Servlet/JSP) |
| | then the externally visible URL will be used in |
| | preference to the “standard” URL that would be |
| | seen in any J2EE Servlet or JSP. If the root level |
| | component is not a Servlet or JSP, no value is |
| | provided. |
| Duration (ms) | Execution time of the root level component in the |
| | Transaction Trace data |
| UserID | If the root level component is a Servlet or JSP, and |
| | the Agent can successfully detect UserID's in the |
| | managed application, the UserID associated with the |
| | JSP or Servlet's invocation. If there is no UserID, or |
| | the UserID cannot be detected, or the root level |
| | component is not a Servlet or JSP, then there will be |
| | no value placed in this column. |

Each transaction that has an execution time greater than the threshold time period will appear in the transaction trace table 800. The user can select any of the transactions in the transaction trace table by clicking with the mouse or using a different means for selecting a row. When a transaction is selected, detailed information about that transaction will be displayed in transaction snapshot 802 and snapshot header 804.

Transaction snapshot 802 provides information about which transactions are called and for how long. Transaction snapshot 802 includes views (see the rectangles) for various transactions, which will be discussed below. If the user positions a mouse (or other pointer) over any of the views, mouse-over info box 806 is provided. Mouse-over info box 806 indicates the following information for a component: name/type, duration, timestamp and percentage of the transaction time that the component was executing. More information about transaction snapshot 802 will be explained below. Transaction snapshot header 804 includes identification of the Agent providing the selected transaction, the timestamp of when that transaction was initiated, and the duration. Transaction snapshot header 804 also includes a slider to zoom in or zoom out the level of detail of the timing information in transaction snapshot 802. The zooming can be done in real time.

In addition to the transaction snapshot, the GUI will also provide additional information about any of the transactions within the transaction snapshot 802. If the user selects any of the transactions (e.g., by clicking on a view), detailed information about that transaction is provided in regions 808, 810, and 812 of the GUI. Region 808 provides component information, including the type of component, the name the system has given to that component and a path to that component. Region 810 provides analysis of that component, including the duration the component was executing, a timestamp for when that component started relative to the start of the entire transaction, and an indication the percentage of the transaction time that the component was executing. Region 512 includes indication of any properties. These properties are one or more of the parameters that are stored in the Blame Stack, as discussed above.

The GUI also includes a status bar 814. The status bar includes indication 816 of how many transactions are in the transaction trace table, indication 818 of how much time is left for tracing based on the session length, stop button 820 (discussed above), and restart button 822 (discussed above).

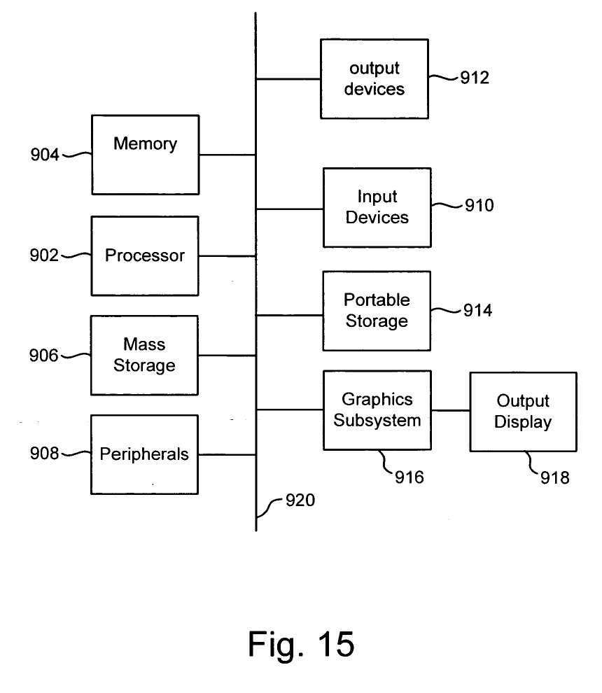

FIG. 15 illustrates a high level block diagram of a computer system which can be used for various components of embodiments. The computer system of FIG. 15 includes a processor unit 902 and main memory 904. Processor unit 902 may contain a single microprocessor, or may contain a plurality of microprocessors for configuring the computer system as a multi-processor system. Main memory 904 stores, in part, instructions and data for execution by processor unit 902. If the system of the present invention is wholly or partially implemented in software, main memory 904 can store the executable code when in operation. For example, main memory may store executable code for software assessment tool 200, which when executed by processor 902, can perform the steps of FIG. 1. Main memory 904 may include banks of dynamic random access memory (DRAM) as well as high speed cache memory.

The system of FIG. 15 further includes a mass storage device 906, peripheral device(s) 908, user input device(s) 910, output devices 912, portable storage medium drive(s) 914, a graphics subsystem 916 and an output display 918. For purposes of simplicity, the components shown in FIG. 15 are depicted as being connected via a single bus 568. However, the components may be connected through one or more data transport means. For example, processor unit 902 and main memory 904 may be connected via a local microprocessor bus, and the mass storage device 906, peripheral device(s) 908, portable storage medium drive(s) 914, and graphics subsystem 916 may be connected via one or more input/output (I/O) buses. Mass storage device 554, which may be implemented with a magnetic disk drive or an optical disk drive, is a non-volatile storage device for storing data and instructions for use by processor unit 902. In one embodiment, mass storage device 906 stores the system software (e.g., tool 202) for implementing embodiments for purposes of loading to main memory 904.

Portable storage medium drive 914 operates in conjunction with a portable non-volatile storage medium, such as a floppy disk, to input and output data and code to and from the computer system of FIG. 15. In one embodiment, the system software for implementing embodiments is stored on such a portable medium, and is input to the computer system via the portable storage medium drive 914. Peripheral device(s) 908 may include any type of computer support device, such as an input/output (I/O) interface, to add additional functionality to the computer system. For example, peripheral device(s) 908 may include a network interface for connecting the computer system to a network, a modem, a router, etc.

User input device(s) 910 provides a portion of a user interface. User input device(s) 910 may include an alpha-numeric keypad for inputting alpha-numeric and other information, or a pointing device, such as a mouse, a trackball, stylus, or cursor direction keys. In order to display textual and graphical information, the computer system of FIG. 15 includes graphics subsystem 916 and output display 918. Output display 918 may include a cathode ray tube (CRT) display, liquid crystal display (LCD) or other suitable display device. Graphics subsystem 916 receives textual and graphical information, and processes the information for output to display 918. Additionally, the system of FIG. 15 includes output devices 912. Examples of suitable output devices include speakers, printers, network interfaces, monitors, etc.

The components contained in the computer system of FIG. 15 are those typically found in computer systems suitable for use with embodiments, and are intended to represent a broad category of such computer components that are well known in the art. Thus, the computer system of FIG. 15 can be a personal computer, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method of creating rankings for applications, comprising:
providing a first set of application inquiries to assess the manageability of a first application;
receiving a response to at least one application inquiry in said first set;
determining a manageability score for said first application based on said response to said at least one application inquiry in said first set;
providing a second set of application inquiries to assess the criticality of said first application;
receiving a response to at least one application inquiry in said second set;
determining a criticality score for said first application based on said response to said at least one application inquiry in said second set; and
creating a ranking for said first application based on said manageability score and said criticality score.

2. The method of claim 1, wherein said providing a first set of application inquiries includes:
providing a plurality of weightings for said first set of application inquiries whereby each application inquiry in said first set has a corresponding weighting;

3. The method of claim 2, wherein said determining a manageability score comprises:
determining a scaled response value for each application inquiry in said first set for which a response is received;
multiplying each scaled response value by the weighting that corresponds to the application inquiry for which said scaled response value was determined, said multiplying resulting in a weighted response value for each application inquiry in said first set for which a response was received; and
determining a sum of each weighted response value for each application inquiry in said first set for which a response was received to obtain said manageability score.

4. The method of claim 3, further comprising for each application inquiry:
providing a plurality of scaled response values;
providing a corresponding range for each scaled response value of said plurality.

5. The method of claim 4, wherein said step of determining a scaled response value for each application inquiry in said first set for which a response was received comprises:
determining which of said plurality of ranges the received response corresponds to; and
determining which of said plurality of scaled response values corresponds to the determined range.

6. The method of claim 1, wherein said step of creating a ranking comprises:
providing a quadrant chart; and
determining a quadrant for said application based on said manageability score and said criticality score.

7. The method of claim 2, wherein said weightings for said set of application inquiries reflect a relative importance of each application inquiry to determining said manageability score.

8. The method of claim 1, wherein said providing a second set of application inquiries includes:
providing a plurality of weightings for said second set of application inquiries whereby each application inquiry in said second set has a corresponding weighting;

9. The method of claim 8, wherein said determining a criticality score comprises:
determining a scaled response value for each application inquiry in said second set for which a response is received;
multiplying each scaled response value by the weighting that corresponds to the application inquiry for which said scaled response value was determined, said multiplying resulting in a weighted response value for each application inquiry in said second set for which a response was received; and
determining a sum of each weighted response value for each application inquiry in said second set for which a response was received to obtain said criticality score.

10. The method of claim 9, further comprising for each application inquiry:
providing a plurality of scaled response values; and
providing a corresponding range for each scaled response value of said plurality.

11. The method of claim 10, wherein said step of determining a scaled response value for each application inquiry in said first set for which a response was received comprises:
determining which of said plurality of ranges the received response corresponds to; and
determining which of said plurality of scaled response values corresponds to the determined range.

12. The method of claim 1, further comprising:
providing a third set of application inquiries to assess a risk exposure of said first application;
receiving a response to at least one application inquiry in said third set;
providing an assessment of an availability of said first application and an assessment of a performance of said first application.

13. The method of claim 12, wherein providing a third set of application inquiries:
providing at least one first inquiry to determine downtime of said first application;
providing at least one second inquiry to determine a desired capacity of said first application; and
providing at least one third inquiry to determine an actual capacity of said first application.

14. The method of claim 14, wherein said step of providing an assessment of an availability of said first application and an assessment of a performance of first said application comprises:
determining and providing an availability percentage of said first application;
determining and providing a performance capacity percentage of said first application.

15. The method of claim 14, wherein providing a third set of application inquiries further comprises:
providing at least one fourth inquiry to determine a type of said first application, said type chosen from a group of types comprising revenue generating, account origination, and service;
providing at least one fifth inquiry to determine a number of transactions for revenue generating applications;
providing at least one sixth inquiry to determine an average value of a transaction for revenue generating applications;
providing at least one seventh inquiry to determine a number of customers served for service applications;
providing at least one eighth inquiry to determine a customer value for service applications;
providing at least one ninth inquiry to determine an estimated number of customers activated for account origination applications; and
providing at least one tenth inquiry to determine a customer value for account origination applications.

16. The method of claim 15, further comprising if said first application is a revenue generating application:
receiving a response to said at least one fifth inquiry and said at least one sixth inquiry;
determining and providing a cost associated with a lack of availability based on said availability percentage, said number of transactions, and said average value of a transaction;
determining and providing a cost associated with poor performance of said application based on said performance capacity percentage, said number of transactions, and said average value of a transaction.

17. The method of claim 15, further comprising if said first application is a service application:
receiving a response to said at least one seventh inquiry and said at least one eighth inquiry;
determining and providing a cost associated with a lack of availability of said first application based on said availability percentage, said number of customers serviced by said first application, and said average customer value;
determining and providing a cost associated with poor performance of said first application based on said performance capacity percentage, said number of customers serviced by said first application, and said average customer value.

18. The method of claim 15, further comprising if said first application is an account origination application:
receiving a response to said at least one ninth inquiry and said at least one tenth inquiry;
determining and providing a cost associated with a lack of availability of said first application based on said availability percentage, said number of new customers activated, and said average customer value; and
determining and providing a cost associated with poor performance of said first application based on said performance capacity percentage, said number of new customers activated, and said average customer value.

19. The method of claim 1, further comprising:
providing, for at least one inquiry in said first set and at least one inquiry in said second set, information for those responding to said application inquiries on how to respond.

20. The method of claim 19, further comprising:
providing, for at least one inquiry in said first set and at least one inquiry in said second set, information for a consultant aiding those responding to said application on how to respond.

21. The method of claim 1, further comprising:
determining whether said manageability score is above a first threshold value; and
determining whether said criticality score is above a second threshold value.

22. The method of claim 21, further comprising:
selecting said first application for performance profiling if said manageability score is above said first threshold value and said criticality score is above said second threshold value.

23. The method of claim 21, further comprising:
selecting said first application for performance profiling if said manageability score is above said first threshold value.

24. The method of claim 23, further comprising:
performing performance profiling for said first application if said first application is selected.

25. The method of claim 24, wherein performing said performance profiling comprises:
adding functionality to a set of code for said first application.

26. The method of claim 25, wherein:
said set of code corresponds to at least one transaction; and
said adding functionality includes adding code to said set of code that activates a tracing mechanism when said at least one transaction starts and terminates said tracing mechanism when said at least one transaction completes.

27. The method of claim 26, further comprising:
determining whether an execution time of said at least one transaction exceeds a threshold trace period;
reporting said first application if said execution time of said at least one transaction exceeds said threshold trace period.

28. The method of claim 25, wherein said set of code is object code.

29. The method of claim 28, wherein said object code is Java byte code.

30. One or more processor readable storage devices having processor readable code embodied on said one or more processor readable storage devices, said processor readable code for programming one or more processors to perform a method comprising:
providing a first set of application inquiries to assess the manageability of a first application;
receiving a response to at least one application inquiry in said first set;
determining a manageability score for said first application based on said response to said at least one application inquiry in said first set;
providing a second set of application inquiries to assess the criticality of said first application;
receiving a response to at least one application inquiry in said second set; and
determining a criticality score for said first application based on said response to said at least one application inquiry in said second set; and
creating a ranking for said first application based on said manageability score and said criticality score.

31. One or more processor readable storage devices according to claim 30, wherein said step of creating a ranking comprises:
providing a quadrant chart; and
determining a quadrant for said first application based on said manageability score and said criticality score.

32. One or more processor readable storage devices according to claim 30, further comprising:
providing a third set of application inquiries to assess a risk exposure of said first application;
receiving a response to at least one application inquiry in said third set; and
providing an assessment of an availability of said first application and an assessment of a performance of said first application.

33. One or more processor readable storage devices according to claim 30, further comprising:
determining whether said manageability score is above a first threshold value;
determining whether said criticality score is above a second threshold value; and
performing performance profiling for said first application if said manageability score is above said first threshold value and said criticality score is above said second threshold value.

34. One or more processor readable storage devices according to claim 33, wherein performing said performance profiling comprises:
adding functionality to a set of code for said first application.

35. One or more processor readable storage devices according to claim 34, wherein:
said set of code corresponds to at least one transaction;
said adding functionality includes adding code to said set of code that activates a tracing mechanism when said at least one transaction starts and terminates said tracing mechanism when said at least one transaction completes.

36. One or more processor readable storage devices according to claim 35, further comprising:
determining whether an execution time of said at least one transaction exceeds a threshold trace period; and
reporting said first application if said execution time of said at least one transaction exceeds said threshold trace period.

37. One or more processor readable storage devices according to claim 34, wherein said set of code is object code.

38. One or more processor readable storage devices according to claim 34, wherein said object code is Java byte code.

39. A method of evaluating applications, comprising:
receiving at least one response to a first set of application inquiries, said first set of application inquiries directed to assessing manageability of a first application and including a weighting for each application inquiry in said first set;
receiving at least one response to a second set of application inquiries, said second set of application inquiries directed to assessing criticality of said first application and including a weighting for each application inquiry in said second set;
determining a manageability score for said first application based on said at least one response to said first set of application inquiries;
determining a criticality score for said first application based on said at least one response to said second set of application inquiries; and
creating a graphical representation based on said manageability score and said criticality score.

40. The method of claim 39, further comprising:
providing said first set of application inquiries and said weighting for each application inquiry in said first set; and
providing said second set of application inquiries and said weighting for each application inquiry in said second set.

41. The method of claim 40, wherein:
said step of determining said manageability score includes determining at least one scaled response value from said at least one response to said first set of application inquiries and multiplying said at least one scaled response value by a corresponding application inquiry weighting;
said step of determining said criticality score includes determining at least one scaled response value from said at least one response to said second set of application inquiries and multiplying said at least one scaled response value by a corresponding application inquiry weighting.

42. The method of claim 39, further comprising:
receiving at least one response to a third set of application inquiries, said third set of application inquiries directed to assessing risk exposure of said first application;
determining an availability percentage of said first application from said at least one response to said third set of application inquiries;
determining an availability cost of said first application from said at least one response to said third set of application inquiries;
determining a performance percentage of said first application from said at least one response to said third set of application inquiries;
determining a performance cost of said first application from said at least one response to said third set of application inquiries.

43. The method of claim 39, further comprising:
providing a quadrant chart having at least four quadrants.

44. The method of claim 43, wherein creating a graphical representation comprises:
plotting said first application in a first quadrant of said quadrant chart if said manageability score is above a first threshold value and said criticality score is above a second threshold value;
plotting said first application is a second quadrant of said quadrant chart if said manageability score is above said first threshold value and said criticality score is at or below said second threshold value;
plotting said first application in a third quadrant of said quadrant chart if said manageability score is at or below said first threshold value and said criticality score is above said second threshold value; and
plotting said first application in a fourth quadrant of said quadrant chart if said manageability score is at or below said first threshold value and said criticality score is at or below said second threshold value.

45. The method of claim 44, further comprising:
selecting said first application for performance profiling if said manageability score is above said first threshold value or said criticality score is above said second threshold value.

46. The method of claim 45, further comprising:
performing said performance profiling for said first application if said first application is selected.

47. The method of claim 46, wherein performing said performance profiling comprises:
adding functionality to a set of code for said first application.

48. The method of claim 47, wherein:
said set of code corresponds to at least one transaction; and
said adding functionality includes adding code to said set of code that activates a tracing mechanism when said at least one transaction starts and terminates said tracing mechanism when said at least one transaction completes.

49. The method of claim 48, further comprising:
determining whether an execution time of said at least one transaction exceeds a threshold trace period; and
reporting said first application if said execution time of said at least one transaction exceeds said threshold trace period.

50. The method of claim 47, wherein said set of code is object code.

51. The method of claim 47, wherein said object code is Java byte code.

52. A method of creating rankings for applications, comprising:
receiving at least one response to a first set of application inquiries, said first set of application inquiries directed to assessing manageability of a first application and including a weighting for each application inquiry in said first set;
receiving at least one response to a second set of application inquiries, said second set of application inquiries directed to assessing criticality of said first application and including a weighting for each application inquiry in said second set;
determining a manageability score for said first application based on said at least one response to said first set of application inquiries;
determining a criticality score for said first application based on said at least one response to said second set of application inquiries; and
performing performance profiling on said first application if said manageability score is above a first threshold value.

53. The method of claim 52, wherein said performance profiling is performed only if said manageability score is above a first threshold value and said criticality score is above a second threshold value.

54. The method of claim 52, wherein performing performance profiling comprises:
adding functionality to a set of code for said first application.

55. The method of claim 54, wherein:
said set of code corresponds to at least one transaction; and
said adding functionality includes adding code to said set of code that activates a tracing mechanism when said at least one transaction starts and terminates said tracing mechanism when said at least one transaction completes.

56. The method of claim 55, further comprising:
determining whether an execution time of said at least one transaction exceeds a threshold trace period; and
reporting said first application if said execution time of said at least one transaction exceeds said threshold trace period.

57. The method of claim 54, wherein said set of code is object code.

58. The method of claim 54, wherein said object code is Java byte code.
